(19) United States
(12) Patent Application Publication
(10) Pub. No.: US 2022/0033704 A1
(43) Pub. Date: Feb. 3, 2022

(54) ALGINATES FOR CORROSION AND SCALE CONTROL

(71) Applicant: Chevron U.S.A. Inc., San Ramon, CA (US)

(72) Inventors: Mark Charlesworth, Woodvale (AU); Christopher John Kalli, Herne Hill (AU); Jon Even Vale, Oslo (NO); Brendan Francis Graham, Parkwood (AU); Eric Freemantle May, Mount Pleasant (AU)

(21) Appl. No.: 17/380,502

(22) Filed: Jul. 20, 2021

Related U.S. Application Data
(60) Provisional application No. 63/054,010, filed on Jul. 20, 2020.

(51) Int. Cl. C09K 8/528; C08B 37/00; C08L 5/04

(52) U.S. Cl. CPC C09K 8/528; C08L 5/04; C08B 37/0084

(57) ABSTRACT

Provided herein are methods for inhibiting the formation of scale on equipment in contact with a produced fluid containing a scale-forming divalent cation. Such methods can comprise adding an activated alginate to the produced fluid in an amount effective to react with the divalent cation in the produced fluid to form an activated alginate complex; and separating the activated alginate complex from the produced fluid. Methods can further comprise recycling the activated alginate from the activated alginate complex by dissolving the activated alginate complex. The activated alginate can be prepared by thermally modifying an alginate precursor at a temperature of from 80° C. to 180° C. for a period of at least 24 hours. The activated alginate can be in the form of a solution including 0.1% to 10% by weight activated alginate, based on the total weight of the solution. The activated alginate can exhibit increased solubility in water and kinetics of complexation with the divalent cation compared to the alginate precursor.

### CROSS-REFERENCE TO RELATED APPLICATIONS

The application claims the benefit of U.S. Provisional Application No. 63/054,010 filed Jul. 20, 2020, which is hereby incorporated herein by reference in its entirety.

### BACKGROUND

A form of corrosion in wet gas pipelines is carbon dioxide corrosion. When carbon dioxide dissolves into the aqueous phase, carbonic acid is formed, which will then dissociate to form carbonate ions. The carbonate ion can then form various insoluble compounds with metal cations. The extent and rate of precipitation are strongly affected by factors such as temperature, pH, concentration of carbon dioxide in the aqueous phase, and the presence of ethylene glycol.

An increase in aqueous carbon dioxide concentration may result in faster corrosion due to the reaction of carbon dioxide and water with iron in carbon steel to form ferrous carbonate and hydrogen. However, this problem can be turned into an advantage through adjustment of the pH. At high pH, ferrous carbonate becomes much less soluble and will precipitate to form a protective coating on the inside wall of the pipeline. Unfortunately, maintaining the fluid at higher pH ranges has the drawback of creating an environment in which scale may form. Produced fluid from production wells may also be present in the pipeline and typically contains calcium ions (Ca²⁺) which will also react with aqueous carbon dioxide to form calcium carbonate scale under high pH. This calcium carbonate will precipitate at moderate to high pH values potentially causing scale deposition on the pipeline wall or form suspended particles that may be carried to the onshore facility.

Acid is commonly used to remove scale deposits; however, this method will also destroy the ferrous carbonate protective layer. A possible solution to this would be to use an antiscalant. These chemicals inhibit the formation of scale by slowing crystal growth or modifying the crystal structure. Common antiscalants include polyphosphate, polyacrylate, and dendrimeric polymers (Sweity et al., 2013). However, effective antiscalants for calcium carbonate inhibition are not selective of calcium carbonate over ferrous carbonate. For example, many antiscalants inhibit the formation of all carbonate scale deposits and while they may not react with a ferrous carbonate layer which has already formed, they will prevent the formation of ferrous carbonate further growth, making them unlikely to be effective in pH stabilized systems in the long term.

There is a need for cost effective and easy to separate biodegradable antiscalants that selectively bind to calcium and reduce or stop precipitation of calcium salts even in the presence of other mono- and divalent ions present in produced fluid. The compositions and methods disclosed herein address these and other needs.

### SUMMARY

Provided herein are methods for inhibiting scale formation, including methods of inhibiting the formation of scale on equipment in contact with a produced fluid containing a scale-forming divalent cation. The methods can comprise adding the activated alginate to the produced fluid in an amount effective to react with the divalent cation in the produced fluid to form an activated alginate complex; and separating the activated alginate complex from the produced fluid. Methods can further comprise recycling the activated alginate from the activated alginate complex. Recycling the alginate complex can comprise dissolving the activated alginate complex by adding an acid, a salt, a washing fluid, or any combination thereof to the activated alginate complex. Separating the activated alginate complex from the produced fluid can be performed by any technique common in the industry for separating two phases such as by gravity, centrifugation, or any combination thereof.

The activated alginate can be prepared by a process that comprises thermally modifying, chemically modifying, or enzymatically modifying an alginate precursor. Thermal modification of the alginate precursor can be performed in an open container (under air) or under an inert atmosphere. The alginate precursor can be thermally modified at a temperature of 80° C. or greater, such as 120° C. or greater, or 140° C. or greater. In some embodiments, the alginate precursor can be thermally modified at a temperature of from 140° C. to 180° C. for a period of at least 24 hours, such as a temperature of about 160° C. for a period of at least 24 hours. The activated alginate can exhibit increased kinetics of complexation with the divalent cation compared to the alginate precursor and increase dissolution rate into solvents such as water and glycol

In some embodiments, the activated alginate can have increased dissolution rate in water, glycol, or any combination thereof compared to the alginate precursor. For example, in some embodiments, the activated alginate can dissolve in less than 60 seconds into water and glycol phases at a concentration of 1% by weight (or at least 5% by weight) at 25° C. compared to hours for alginate precursor. In some embodiments, the activated alginate can have a viscosity in water of at 5% w/w of 10 cP or less at 4° C. In some embodiments, the activated alginate can have an average particle size diameter of 1.4 μm or less, 1.0 μm or less, or 500 nm or less. In some embodiments, the activated alginate can have a molecular weight of 500,000 Da or less.

The activated alginate can be in the form of an activated alginate solution comprising 0.1% to 10% by weight of activated alginate, based on the total weight of the solution. The divalent cation and the activated alginate can be present in a ratio of 300 ppm divalent cation to 1% w/w activated alginate, where the divalent cation is a calcium cation. The equipment in contact with the produced fluid can be a pump or a separator or a pipeline carrying produced fluid and the produced fluid having a pH from 7 to 12.

### DESCRIPTION OF DRAWINGS

FIG. 1 is a plot of relation between data obtained by solid state NMR and the accepted structure obtained by solution NMR.

FIGS. 2A and 2B is a graph of alginate 5 (High viscosity, Low G) in aqueous solution at 1% w/w (2A), in solution aqueous 300 ppm solution at 1% w/w (2B).

FIGS. 3A and 3B is a graph of alginate 4 (Mid viscosity, High G) in aqueous solution at 1% w/w (3A), in solution aqueous 300 ppm solution at 1% w/w (3B).

FIGS. 4A and 4B is a graph of alginate 3 (Low viscosity, High G) in aqueous solution at 1% w/w (4A), in solution aqueous 300 ppm solution at 1% w/w (4B).

FIG. 5 is a graph showing the raw calcium concentration and the effect of dilution on calcium concentration.

FIG. 6 is a graph showing the percentage of calcium removed after correction for dilution effects and differing initial starting concentrations.

FIG. 7 is a graph showing the calcium binding efficiency of all five alginates at 1% w/w concentration.

FIG. 8 is a graph showing the effect of pH on alginate 3.

FIG. 9 is a graph showing the effect of pH on alginate 4.

FIG. 10 is a scheme showing the acidic protons that are ionized above pH 4 that become the calcium binding sites.

FIG. 11 is a graph showing the calcium removal with addition of alginate 3 at different temperatures.

FIG. 12A-12D is a graph showing alginate 3 and 4 efficacy in the presence of divalent ions (12A); mono- and divalent ions (12B); high levels of Mg2+ ions (12C); or high levels of Fe2+ ions (12D).

FIGS. 13A and 13B is a graph showing the percentage drop in calcium in the receiving beaker with the addition of 1% w/w alginate (13A); or 1% w/w alginate at pH 10 (13B). The data is corrected for concentration decrease due to dilution.

FIG. 14 is a scheme for recycling of alginate.

FIGS. 15A and 15B is a graph showing the decrease in calcium ion concentration due to alginate addition (15A); or regenerated alginate addition (15B). The data has been normalized to remove the effect of dilution.

FIG. 16 is a thermogram of alginate 2 showing degradation temperature.

FIG. 17 is a derivative of the FIG. 16 thermogram highlighting the degradation temperature (dotted line).

FIG. 18 is a graph showing the stability of alginate 3 powder at 150° C. for 60 minutes.

FIG. 19 is a graph showing the high degree of reproducibility of alginate Titrations.

FIG. 20A-20D is a graph showing stability trials at room temperature (20A); at room temperature and pH12 (20B); at 80° C. (20C); or at 160° C. (20D).

FIG. 21 is a graph comparing the heat treated (triangle) and normal (square) alginate powder in calcium binding efficacy.

FIG. 22 is a graph showing the size distribution of alginate and degraded alginate obtained from dynamic light Scattering.

FIG. 23A-23D is a graph showing flow curves for 1% w/w alginate 3 solution (23A); 1% w/w thermally degraded alginate 3 solution (23B); 2% w/w thermally degraded alginate 3 solution (23C); 5% w/w thermally degraded alginate 3 solution at 4° C. and 20° C. (23D).

FIG. 24 is a graph showing titration curves with different alginate concentrations.

FIG. 25 is a graph showing titration curves of 1% alginate into solutions of differing calcium concentration.

FIG. 26 is a graph showing a titration curve showing effect of gel removal.

FIG. 27 is a comparison plot of two experiments showing the effect of gel removal.

FIG. 28 is a graph showing the titration of 300 ppm calcium solution against: pH 12 water (diamond) and pH 12 alginate solution (square).

### DETAILED DESCRIPTION

Definitions: To facilitate understanding of the disclosure set forth herein, a number of terms are defined below. Unless defined otherwise, all technical and scientific terms used herein have the same meanings as commonly understood by one of skill in the art to which the disclosed invention belongs. Publications cited herein and the materials for which they are cited are specifically incorporated by reference.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

As used in this specification and the following claims, the terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. For example, the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Accordingly, these terms are intended to not only cover the recited element(s) or step(s), but may also include other elements or steps not expressly recited. Furthermore, as used herein, the use of the terms “a”, “an”, and “the” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent of the given numeric value provided such a deviation does not alter the end function or result of the value. Therefore, a value of about 1% can be construed to be a range from 0.9% to 1.1%. Furthermore, a range may be construed to include the start and the end of the range. For example, a range of 10% to 20% (i.e., range of 10%-20%) can includes 10% and also includes 20%, and includes percentages in between 10% and 20%, unless explicitly stated otherwise herein. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if a composition is described herein as including a component of type A, a component of type B, a component of type C, or any combination thereof, it is understood that this phrase describes all of the various individual and collective combinations and permutations of these components. For example, in some embodiments, the composition described by this phrase could include only a component of type A. In some embodiments, the composition described by this phrase could include only a component of type B. In some embodiments, the composition described by this phrase could include only a component of type C. In some embodiments, the composition described by this phrase could include a component of type A and a component of type B. In some embodiments, the composition described by this phrase could include a component of type A and a component of type C. In some embodiments, the composition described by this phrase could include a component of type B and a component of type C. In some embodiments, the composition described by this phrase could include a component of type A, a component of type B, and a component of type C. In some embodiments, the composition described by this phrase could include two or more components of type A (e.g., A1 and A2). In some embodiments, the composition described by this phrase could include two or more components of type B (e.g., B1 and B2). In some embodiments, the composition described by this phrase could include two or more components of type C (e.g., C1 and C2). In some embodiments, the composition described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the composition described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the composition described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed.

By “reduce” or other forms of the word, such as “reducing” or “reduction,” is meant lowering of an event or characteristic (e.g., a quantity of scale on equipment). As compared with an equivalent untreated control, such a reduction can be at least a 5%, 10%, 20%, 40%, 50%, 60%, 80%, 90%, 95%, or 100% reduction as measured by any standard technique known in the art (e.g., by weight).

By “prevent” or other forms of the word, such as “preventing” or “prevention,” is meant to stop a particular event or characteristic, to stabilize or delay the development or progression of a particular event or characteristic, or to minimize the chances that a particular event or characteristic will occur. Prevent does not require comparison to a control as it is typically more absolute than, for example, reduce. As used herein, something could be reduced but not prevented, but something that is reduced could also be prevented. Likewise, something could be prevented but not reduced, but something that is prevented could also be reduced.

By “inhibit” or other forms of the word, such as “inhibiting” or “inhibition,” is meant reduce (as defined above), prevent (as defined above), or any combination thereof. Thus, in some embodiments, inhibition of scale can refer to a reduction in scale (e.g., a decrease in the quantity of scale formed on equipment). In other embodiments, inhibition of scale can refer to a prevention of scale (e.g., a halt or delay in the formation of scale on equipment). In other embodiments, inhibition of scale can refer to both a reduction in scale and a prevention of scale. It will be understood that where inhibition is used in this disclosure, unless indicated otherwise, reduction and/or prevention are also expressly disclosed.

The term “scale inhibitor” as used herein refers to a chemical agent, compound, or substance that is used to reduce or prevent scale (e.g., mineral salt deposits, calcium carbonate, calcium sulfate, barium sulfate, strontium sulfate, iron sulfide, iron oxides, iron carbonate, silicates, phosphates, and oxides) deposition. The scale formation quantity can be reduced or the character of the scale formation can be changed, e.g., the adherent nature of the scale is reduced, or the scale becomes semi-solid or as a gel.

“Effective amount” refers to an amount sufficient to effect a measurable difference over not including the amount. The effective amount of a composition can be determined by for example, the location of the pipeline, the nature and extent of the scale formation, the frequency of the treatment, the type of concurrent treatment, if any; and standard oil and gas practice.

“Pipeline” as used herein may include practically any tubular, conduit, pipeline, or pipe, such as in the oil and gas industry. In some embodiments, the term “pipeline” may even include a wellbore or components thereof. The pipeline can carry produced fluid or other fluid.

“Equipment” as used herein may include any equipment used in an oil and gas operation, such as a vessel, pipeline, holding tank, separator, pipe, wellbore, or any combination thereof. In certain cases, the equipment can include equipment in contact with a produced fluid, for example, equipment such as pumps or separators or a pipe or a pipeline carrying produced fluid having a pH from 7 to 12.

“Scale,” “calcium scale” and “calcium salt scale” as used herein include all scale comprising a water insoluble or slightly soluble salt formed from divalent cations, e.g., calcium, magnesium, barium, strontium, etc.

“Produced fluid” may be used interchangeably with produced water, and refer to mixtures of hydrocarbons and water that is typically extracted from a formation. As used herein, produced fluid also includes fracture fluids, which can be recycled produced water or water from co-located wells for use in creating fractures in a formation such as an unconventional (e.g., shale) formation (sometimes can be referred to as “brine”). Produced fluid may also contain glycols that have been injected into the well to prevent hydrate formation. Produced fluid may include formation water (e.g., connate water), produced water, hydrocarbons, gas, or any combination thereof. Also, sometimes the terminology “produced fluids” and “produced fluid” is used interchangeably herein. The terminology “well” and “wellbore” is also used interchangeably herein.

Reference will now be made in detail to specific aspects of the disclosed materials, compositions, articles, and methods, examples of which are illustrated in the Examples section.

Compositions: The presence of divalent cations such as calcium and magnesium in produced fluids can result in the formation of inorganic and organic salts (known as scales) that may impede production/extraction of hydrocarbons, or limit the ability to manage water in surface facilities and subsurface injection facilities. Disclosed herein are compositions and methods to inhibit scale formation, deposition, and/or adherence thereof in equipment, facilities, and operations for the exploration, production, and/or processing of hydrocarbons.

The scale inhibiting compositions disclosed herein can comprise an activated alginate. The activated alginate can exhibit an affinity for divalent cations (e.g., calcium), thus obviating the formation of the solid inorganic and or organic scales. The complexing and non-gel solid forming properties of the activated alginate can be conveniently used to inhibit the formation and adherence of solid scales for oil and gas applications. As most if not all of the scale forming materials in produced fluid, e.g., the calcium ions, the magnesium ions, the barium ions, etc., react with the activated alginate instead of hard-scale on pipes and equipment, the occurrence of scale on equipment can be significantly reduced if not prevented by employing an activated alginate. Scale formation can be reduced at least 75% compared to an occurrence without any alginate treatment/addition in one embodiment; at least 90% reduction in a second embodiment; at least 95% reduction in a third embodiment; at least 99% reduction in a fourth embodiment, and of from 75% to 99% reduction in a fifth embodiment.

The activated alginate can be derived from an alginate precursor that has been modified. In certain embodiments, the activated alginate precursor can be an alginate that provides the main structural component of brown algae (seaweeds). Such alginates have been primarily used in the biomedical industry, e.g., for creating a moist healing environment for the management of chronic wounds; or used as a stabilizer, thickener, and emulsifier in the food industry; or for use in biomedical applications as a diet-aid supplement. While the alginate precursors may exhibit complexing properties with scales, they form gels that are inconveniently formed during adherence of solid scales for oil and gas applications.

The activated alginate can be linear copolymers of (1-4) linked β-d-mannuronic acid (M) and α-1-guluronic acid (G). The distribution of M and G in alginate chains gives rise to three different block types, namely blocks of poly-M, blocks of poly-G, and alternating MG blocks. Some characteristics of the activated alginate can be influenced by the content of the G blocks, and also their length. The properties of activated alginate in solution is dependent on temperature, pH, and the ionic content of the solvent. The activated alginate can react with Ca²⁺ ions to form an activated alginate complex, the properties of which will also depend on the above-mentioned variables.

In some embodiments, the activated alginate has a pre-selected M/G ratio suitable for the environment where the activated alginate is injected and optimum for the pH and temperature of the produced fluid, as well as the concentration and type of scale forming materials (e.g., calcium or magnesium ions, inorganic or organic scale forming materials). In some embodiments, the activated alginate has a ratio of mannuronic acid to guluronic acid (M/G) of any of less than 1; less than 0.7; and less than 0.5. In other embodiments for use with produced fluid having a low pH, the activated alginate has a larger amount of guluronic acid compared to mannuronic acid, e.g., where guluronic acid is above 60% and the amount of mannuronic acid is below 40% of the total content of activated alginate. In yet other embodiments, the ratio of beta-D mannuronic acid to alpha-L guluronic acid in the activated alginate is equal to or above 1. In some embodiments, the activated alginate has a G-content above any of 30%; 40%; and 50%. In one embodiment wherein most of the scale formation is expected from barium or strontium ions, the activated alginate employed has an M/G ratio ranging from 0.01 to 0.8.

In yet another embodiment, the activated alginate has a G-content of more than or equal to 50% (e.g., at least 50%). For example, a G-content of more than or equal to 50% (e.g., at least 50%) may be used where scale formation is expected to be from calcium. In yet another embodiment, the activated alginate has a G-content of more than or equal to 60% (e.g., at least 60%). In yet another embodiment, the activated alginate has a G-content of more than or equal to 70% (e.g., at least 70%). In yet another embodiment, the activated alginate has a G-content of 50% to 80%. In yet another embodiment, the activated alginate has a G-content of 50% to 70%. In yet another embodiment, the activated alginate has a G-content of 50% to 60%. In yet another embodiment, the activated alginate has a G-content of 50% to 55%. In yet another embodiment, the activated alginate has a G-content of 55% to 60%. In yet another embodiment, the activated alginate has a G-content of 60% to 80%. In yet another embodiment, the activated alginate has a G-content of 60% to 70%. In yet another embodiment, the activated alginate has a G-content of 60% to 65%. In yet another embodiment, the activated alginate has a G-content of 65% to 75%. In yet another embodiment, the activated alginate has a G-content of 55% to 70%.

In one embodiment for the inhibition of calcium forming scale, the activated alginate has a weight ratio of M/G block ranging from 0.33:1 to 1:1. In another embodiment, the activated alginate has a weight ratio of M/G block from 0.45:1 to 1:1. In another embodiment, the activated alginate has a weight ratio of M/G block from 0.33:1 to 0.75:1. In another embodiment, the activated alginate has a weight ratio of M/G block from 0.45:1 to 0.75:1. In another embodiment, the activated alginate has a weight ratio of M/G block from 0.5:1 to 0.75:1. In another embodiment, the activated alginate has a weight ratio of M/G block from 0.6:1 to 0.75:1. In another embodiment, the activated alginate has a weight ratio of M/G block from 0.70:1 to 0.75:1.

The affinity of the activated alginate for cations is related to the quantity of G residues in the activated alginate, as when two G residues are adjacent in the polymer they form a binding site for polyvalent cations. The gel-forming involves the binding or chelating of the scale-forming ions such as magnesium, barium, calcium, etc., inside the structure of two guluronic acid (G blocks) of the alginate structure.

The activated alginate can have an improved water solubility compared to the alginate precursor. In some instances, the activated alginate can have a water solubility of greater than 1 g/100 g water at 20° C. For example, the solubility of the activated alginate in water, measured at 20° C., can be 0.8 g/100 g water or greater, 0.6 g/100 g water or greater, 0.2 g/100 g water or greater, 0.1 g/100 g water or greater, 0.05 g/100 g water or greater, 0.03 g/100 g water or greater, or 0.01 g/100 g water or greater.

In some embodiments, the activated alginate can have an increased dissolution rate in water, glycol, or any combination thereof compared to the alginate precursor. In some embodiments, the activated alginate can dissolve in water, glycol, or any combination thereof in less than 60 seconds (e.g., 50 seconds or less, 40 seconds or less, 30 seconds or less, 20 seconds or less, or 10 seconds or less) a concentration of 1% by weight (or 5% by weight) at 25° C. In some embodiments, the activated alginate can dissolve in water, glycol, or any combination thereof in 10 seconds or more (e.g., 20 seconds or more, 30 seconds or more, 40 seconds or more, or 50 seconds or more) at a concentration of 1% by weight (or 5% by weight) at 25° C.

The activated alginate can dissolve within a time period ranging from any of the minimum values described above to any of the maximum values described above. For example, in some embodiments, the activated alginate can dissolve in water, glycol, or any combination thereof in from 10 seconds to less than 60 seconds, (e.g., from 10 seconds to 50 seconds, from 10 seconds to 40 seconds, from 10 seconds to 30 seconds, from 10 seconds to 20 seconds, from 20 seconds to 30 seconds, from 20 seconds to 40 seconds, from 20 seconds to 40 seconds, from 20 seconds to 50 seconds, from 20 seconds to less than 60 seconds, from 30 seconds to 40 seconds, from 30 seconds to 50 seconds from 30 seconds to less than 60 seconds, from 40 seconds to 50 seconds, from 40 seconds to less than 60 seconds, or from 50 seconds to less than 60 seconds) at a concentration of 1% by weight (or 5% by weight) at 25° C.

In some embodiments, the activated alginate can have a weight average molecular weight of at least 5,000 Da (e.g., at least 10,000 Da, at least 25,000 Da, at least 50,000 Da, at least 75,000 Da, at least 100,000 Da, at least 250,000 Da, or at least 500,000 Da). In some embodiments, the activated alginate can have a weight average molecular weight of 1,000,000 Da or less (e.g., 500,000 Da or less, 250,000 Da or less, 100,000 Da or less, 75,000 Da or less, 50,000 Da or less, 25,000 Da or less, or 10,000 Da or less).

The activated alginate can have a weight average molecular weight ranging from any of the minimum values described above to any of the maximum values described above. For example, in some embodiments, the activated alginate can have a weight average molecular weight of from 5,000 Da to 1,000,000 Da, (e.g., from 10,000 Da to 1,000,000 Da, from 25,000 Da to 1,000,000 Da, from 50,000 Da to 500,000 Da, from 50,000 Da to 250,000 Da, from 100,000 Da to 250,000 Da, or from 100,000 Da to 200,000 Da).

In some embodiments, the activated alginate can have a viscosity in water at 5% w/w measured at 4° C. of at least 1 cP (e.g., at least 2.5 cP, at least 5 cP, or at least 7.5 cP). In some embodiments, the activated alginate can have a viscosity in water at 5% w/w measured at 4° C. of 10 cP or less (e.g., 7.5 cP or less, 5 cP or less, or 2.5 cP or less).

The activated alginate can have a viscosity ranging from any of the minimum values described above to any of the maximum values described above. For examples, in some embodiments, the activated alginate can have a viscosity of from 1 cP to 10 cP, (e.g., from 1 cP to 7.5 cP, from 1 cP to 5 cP, from 1 cP to 2.5 cP, from 2.5 cP to 7.5 cP, from 2.5 cP to 5 cP, from 5 cP to 7.5 cP, or from 5 cP to less than 10 cP).

In some embodiments, the activated alginate can have an average particle size diameter of at least 0.5 μm, (e.g., at least 0.75 μm, at least 1.0 μm, or at least 1.25 μm). In some embodiments, the activated alginate can have an average particle size diameter of 1.4 μm or less as measured by microscopy (e.g, 1.25 μm or less, 1.0 μm or less, or 0.75 μm or less).

The activated alginate can have an average particle size diameter ranging from any of the minimum values described above to any of the maximum values described above. For examples, in some embodiments, the activated alginate can have an average particle size diameter of from 0.5 μm to 1.4 μm, (e.g., from 0.5 μm to 1.25 μm, from 0.5 μm to 1.0 μm, from 0.5 μm to 0.75 μm, from 1.0 μm to 1.25 μm, from 1.0 μm to 1.4 μm, from 1.25 μm to 1.4 μm, from 0.75 μm to 1.0 μm, from 0.75 μm to 1.25 μm, or from 0.75 μm to 1.4 μm).

The alginate precursor can form gels of highly hydrated alginate polymers. A gel, in classical colloid terminology, is a system which owes its characteristic properties to a cross-linked network of polymer chains which form at the gel point. In contrast, when the activated alginate liquor is used to bind calcium in a normal titration, a gel is not formed. Instead, small brown platelets are formed including of the activated alginate and calcium. These platelets do not bind up the excess water allowing these platelets to easily flow in solution.

The activated alginate can be in the form of an activated alginate solution. In one embodiment, the activated alginate is added to the produced fluid as a solution of 0.1 to 10% activated alginate or 0.3 to 5% activated alginate, and at a ratio of sodium ions to calcium ions ranging from 10:1 to about 50:1. In yet another embodiment, the activated alginate is added as a solution of less than or equal to 5% activated alginate, less than or equal to 3% activated alginate, less than or equal to 2% activated alginate, or less than or equal to 1% activated alginate.

In some embodiments, the activated alginate can be added to the produced fluid as a solution of at least 0.1% activated alginate, (e.g., at least 0.5% activated alginate, at least 1% activated alginate, at least 2.5% activated alginate, at least 5% activated alginate, or at least 7.5% activated alginate). In some embodiments, the activated alginate be added to the produced fluid as a solution of 10% or less activated alginate (e.g., 7.5% or less activated alginate, 5% or less activated alginate, 2.5% or less activated alginate, 1% or less activated alginate, 0.75% or less activated alginate, or 0.5% or less activated alginate).

The activated alginate can be added to the produced fluid as a solution ranging from any of the minimum values described above to any of the maximum values described above. For examples, in some embodiments, the activated alginate can be added to the produced fluid as a solution of from 0.1% activated alginate to 10% activated alginate, (e.g., from 0.1% activated alginate to 7.5% activated alginate, from 0.1% activated alginate to 5% activated alginate, from 0.1% activated alginate to 2.5% activated alginate, from 0.1% activated alginate to 1% activated alginate, from 0.1% activated alginate to 0.5% activated alginate, from 0.5% activated alginate to 10% activated alginate, from 0.5% activated alginate to 7.5% activated alginate, from 0.5% activated alginate to 5% activated alginate, from 0.5% activated alginate to 2.5% activated alginate, from 0.5% activated alginate to 1% activated alginate, from 1% activated alginate to 10% activated alginate, from 1% activated alginate to 5% activated alginate, from 1% activated alginate to 2.5% activated alginate, from 2.5% activated alginate to 10% activated alginate, from 2.5% activated alginate to 5% activated alginate, from 5% activated alginate to 7.5% activated alginate, from 5% activated alginate to 10% activated alginate, or from 7.5% activated alginate to 10% activated alginate).

In one embodiment, the activated alginate composition is a mixture of different alginates with different M/G ratios and/or different viscosities to provide the desired effects, e.g., the composition will be readily soluble in water, such that the composition can be easily used to prepare an aqueous preparation without substantive mixing. The activated alginate composition can be in the form of a solution, slurried, and/or dissolved in a carrier fluid, e.g., water, mono ethylene glycol (MEG), etc., in a sufficient amount for the activated alginate to effectively complex with the scale-forming cations in the produced fluid. A sufficient amount means an amount for the activated alginate to effectively complex with the scale-forming cations in the produced fluid at greater than 75%, at least 90%; at least 95%; and at least 99%.

In one embodiment, the activated alginate can be used to inhibit scale when the quantity of divalent cations in the produced fluid is between about zero divalent cations (e.g., less than 10 ppm) and saturated produced fluid of divalent cations (e.g., calcium ions). For example, an upper limit may be determined by the saturation point for the cations (e.g., calcium ions) which is dependent on fluid composition and conditions.

In some embodiments, the activated alginate composition can optionally comprise one or more additives. For example, in some embodiments, the activated alginate composition can further comprise a preservative such as benzoic acid, potassium sorbate, sodium benzoate, or any combination thereof to prevent the microbial growth. In other embodiments, a sufficient amount of a base can be added to the activated alginate composition/carrier fluid (e.g., MEG) to adjust the pH to obtain a desired/suitable set of rheological properties for transport through a pipeline.

Methods for Inhibiting Scale Formation: Compositions comprising an activated alginate can be utilized in methods for inhibiting scale formation, including those described in U.S. Pat. No. 10,427,963 and U.S. Patent Application Publication No. US2020/0002206, each of which is incorporated by reference herein.

Described herein are methods for inhibiting the formation of scale on equipment in contact with a produced fluid containing a scale-forming divalent cation. The equipment in contact with the produced fluid can be, for example, equipment such as pumps or separators or a pipe or a pipeline carrying produced fluid having a pH from 7 to 12. In one embodiment, the method can include adding an activated alginate to the produced fluid in an amount effective to react with the divalent cation in the produced fluid to form an activated alginate complex; and separating the activated alginate complex from the produced fluid. Separating the activated alginate complex from the produced fluid can be performed by gravity, centrifugation, or any combination thereof.

In one embodiment, the activated alginate can be prepared by a process including thermally modifying, chemically modifying, or enzymatically modifying an alginate precursor. In one embodiment, the activated alginate is prepared by a process including thermally modifying the alginate precursor. Thermal modification of the alginate precursor can be performed in an open container or under an inert atmosphere. The alginate precursor can be thermally modified at a temperature of 80° C. or greater or 150° C. or greater. The temperature can be from 80° C. to 180° C. for a period of at least 24 hours. In one embodiment, the method can include thermally modifying an alginate precursor under conditions effective to afford an activated alginate having a water solubility of at least 0.01 g/100 g water or greater. In one embodiment, the method further includes recycling the activated alginate from the activated alginate complex. Recycling the activated alginate complex can include dissolving the activated alginate complex by adding an acid, a salt, or a washing fluid to the activated alginate complex.

In one embodiment, the amount and type of alginates to be injected for scale inhibition can be determined from a reference database. The reference database is used to characterize the scale inhibition characteristics of a selected alginate, as well as the optimization and blending of alginate compositions for optimal scale inhibiting results. The reference database can contain correlations of any of the alginate properties, e.g., ratio of the M & G blocks of alginates, viscosity, and solubility with: a) properties of produced fluids including but not limited to the uptake of divalent cations, viscosity, the amount of monovalent salts in the produced fluid, etc.; and b) properties of activated alginate complex products.

In one embodiment, the divalent cation scale forming profile in the produced fluid is first determined, along with the characteristics of the produced fluid, e.g., pH, operating temperature, components, iron level, etc. In the next step based on the correlations, an activated alginate with a particular M/G ratio is selected to enhance the functionality of the activated alginate to reduce the crystal growth of the scale by maximizing the uptake of scale-forming divalent cations, e.g., Ca²⁺, from the produced fluid into a calcium-alginate complex, with suitable rheological properties for transport through pipeline infrastructure or for subsequent inhibition using methods known in the art.

In one embodiment for the inhibition of scale formation in a pipeline, the activated alginate can be introduced into the pipeline by itself, or with a carrier fluid such as MEG, into the production well at the well head, into a manifold, into a location downhole in the wellbore, at an intermediate location of the pipeline between the production well and a processing facility (e.g., brine treatment facility, glycol treatment facility or glycol processing plant, etc.), at intervals along the pipeline, or any combination thereof.

The activated alginate complexes may be removed downstream and the alginate recovered for reuse by any combination of mechanical and chemical means known in the art, e.g., by settling, sieving, using a centrifuge or cyclone, pH adjustment and elution.

Scale Inhibiting Applications: The use of activated alginate for scale inhibition and control can be particularly advantageous for conditions where the use of common scale inhibitors may not be viable. These scenarios include but are not limited to: a) operations with high pH (e.g., a pH greater than 9, or a pH greater than 10), high saturation ratio (e.g., above 80% saturation) or high temperatures (e.g., temperatures above 80° C., or above 100° C.) or in areas where the brine is re-used or re-injected; b) systems where corrosion is managed by a ‘pH stabilization’ method; c) operations and processes for the preparation, storage and use of fracture fluids; d) glycol distillation system for the pre-treatment of produced fluids; e) operations wherein the scale comprises calcium naphthenate/carboxylate salts, solids and emulsions; and processes involving high iron, oxygenated systems; f) sour water stripping system; g) systems with high contents of both Ca and SO₄ to result in high scaling risk of CaSO₄ based minerals; h) operations where the produced fluid includes sulfur; i) operations where the produced fluid includes sulfates; j) other operation; k) any combination thereof; l) etc.

Types of Scale Formation: The scale formation to be inhibited can be inorganic, organic, and/or mixtures thereof. Inorganic scales can deposit throughout the entire production and processing system used for oil & gas production. The most common type of inorganic scale formed in oil and gas operations is calcium carbonate. The driving forces for calcium carbonate deposition are primarily increases in pH and increases in temperature, as in the prior art, the use of scale inhibitor chemicals for calcium scale control is most common in low to moderate pH environments.

Organic scales such as calcium carboxylate or naphthenate salts are less common than inorganic scales, but can cause severe processing and maintenance issues in surface facilities. The formation of these salts can occur during the production of hydrocarbons that contain naphthenic type acids in conjunction with produced waters that contain calcium. During the production and processing of these fluids, the reduction in pressure causes the pH of the brine to increase as a result of the dissolution of acidic gasses, thus allowing the naphthenic acid species to form salts with the calcium ions.

Scale Inhibition in Gas Production Pipelines Employing pH Stabilization: pH stabilization can be used as a method to control CO₂ corrosion in gas production pipelines. In this technique, a high pH base (e.g., NaOH, MDEA, KOH, etc.) is used to promote the formation of iron carbonate scale as a passivating film to protect the internal pipe wall from on-going corrosion. A prerequisite for pH stabilization method is that the pipeline does not carry formation water, since the presence of calcium ions from formation water may lead to a calcium carbonate formation in the elevated pH environment of the system. In the prior art with the use of scale inhibitors for pH stabilized systems, the kinetics of iron carbonate deposition can be affected with growth and resultant density of the iron carbonate passivating layer, which could compromise the ability of the pH stabilization method to control corrosion in the pipeline. The use of activated alginate as a scale inhibition/control method obviates the scale formation while allowing the formation of the iron carbonate passivating layer.

Preparation of Fracture Fluids: Activated alginate can also be used for controlling/inhibiting scale formation in the preparation, storage, and use of fracture fluids. In one embodiment of a hydraulic fracturing operation, there is a desire to use recycled produced water or alternatively, co-located water source wells to supply brine for the preparation of fracture fluids. This often leads to the use of waters that contain divalent ions (e.g., calcium, magnesium, etc.) for preparation of the final fracture fluid. If levels of divalent cations in the brines are high enough, this can result in scale deposition occurring in equipment during the preparation of the fracturing fluid. Scale deposition would lead to equipment downtime and cleaning, and may necessitate the use of acids or other scale solvents to remove the deposits. If the scale were to deposit downhole during the use of the fracture fluid, this may reduce post-frac production from the well. In the prior art, water to be used as “brine” may be pre-treated or “softened” to remove divalent cations such as calcium prior to its use, with techniques such as lime softening and/or ion exchange to reduce the calcium level sufficiently to inhibit inorganic scale precipitation. The use of alginates as a scale inhibitors can obviate the water pre-treatment step.

Glycol Distillation Systems: The method for inhibiting scaling of glycol distillation systems in the prior art adds large volumes of alkali chemicals (e.g., NaOH, KOH, K₂CO₃, etc.) to rich glycol (e.g., a mixture of produced water and glycol typically containing 40-70% MEG), in a heated pre-treatment system to forcibly precipitate and remove divalent salts, prior to distillation of rich glycol. In one embodiment, activated alginate is used to remove calcium and other divalent ions from the rich glycol, thus obviating the need for the handling of large volumes of alkali chemicals and the requirement for heating the rich glycol prior to distillation.

Systems with Organic Scales & Emulsions: During the production and processing of hydrocarbons that contain naphthenic type acids in conjunction with produced waters that contain divalent cations such as Ca²⁺ or Mg²⁺, the reduction in pressure can cause an increase in the pH of the brine, allowing the naphthenic acid species to form salts with the divalent cations. The presence of naphthenate salts result in emulsions and solid deposition. Commercially available scale inhibitors may not be effective on these types of organic salts; hence the scale formation is typically controlled by process optimization or by the use of large volumes of acid to suppress the pH. The use of activated alginate to control/inhibit the organic scale formation obviates the need for process optimization in the prior art, which may include controlling the rate of depressurization of the fluids, injection of demulsifiers, and/or injection of organic or mineral acids into the produced fluid stream to maintain the pH to inhibit calcium naphthenate formation.

High Iron/Oxygenated Systems: Many common scale inhibitor products are ineffective when Fe²⁺ levels exceed 50-100 ppm in produced fluid. In addition, Fe³⁺ will also render common scale inhibitors ineffective if present in the produced fluid at levels >1 ppm. The use of activated alginate facilitates the control/inhibition of scale formation in high iron, oxygenated systems, obviating the need for remedial treatment such as pipeline removal or chemical cleaning to remove scale formation.

Sour Water Stripping Systems: Sour water stripping is widely used to remove sulfides from produced water so that it can be safely and reliably disposed of, re-injected, or re-used after proper treatment. The sour water is sent through a stripping tower where a gas (usually steam) stream is applied to force H₂S and in the meanwhile, CO₂, out of the water phase. By removing these acidic components from the produced water, the process usually results in increased pH, and consequently leads to a higher scaling risk of CaCO₃. In some scenarios seen in the field, the Ca concentration in the produced water is so high that commercial inhibitors, such as NTMP, would be ineffective. Ca removal through pre-precipitation (softening) or pH adjustment of the produced water is usually recommended to control such scaling risk in the prior art. The use of activated alginate reduce the availability of Ca to form CaCO₃ precipitation, and could thus obviate the needs for these pretreatment processes.

High Ca/SO₄ systems: Although CaSO₄ scaling is not as common as BaSO₄ and CaCO₃ due to its relatively high solubility, it has been seen in the field that systems with high concentrations of both Ca and SO₄ can have significant scaling risk of CaSO₄ based minerals (e.g., gypsum, hemihydrite, anhydrite, etc.) that are difficult to inhibit due to the large amounts of potential precipitation. If pH is lowered in the same system to control the scaling of carbonates/sulfides, the availability of Ca is further increased to induce more CaSO₄ scale, which is not sensitive to change in pH. Ca reduction might be the only viable option in these systems. Although processes such as softening precipitation or membrane filtration can be utilized to pre-treat the water, activated alginate could be dosed in the same water to chelate Ca and obviate these pretreatment needs.

Various other alternatives or modifications are also possible. For example, the separating and removal steps may be accomplished in other ways. In one example, separation of the platelets from the fluids could be by settling in a pond/tank and then removal of the platelets from the pond/tank, with the fluids remaining in the pond/tank or overflowing from the pond/tank (e.g., fluids overflowing into another container). In another example, a form of filtration or cyclonic separation can be used where the fluids and the platelets undertake simultaneous separation and removal. In another example, removing the platelets from the produced fluid is more about removing the calcium/divalent cations from the system.

Depending on the embodiment, the separating step, removing step, and redissolving steps can be performed as three separate steps. Depending on the embodiment, some or all of the separating step, removing step, and redissolving step can be combined. Depending on the embodiment, at least one of the separating step, removing step, or redissolving step can be omitted. Also, as indicated above, the separating step can be a phase separating step in some embodiments. Those of ordinary skill in the art will appreciate that the inventive concepts are not limited to the examples provided herein.

This written description uses examples to disclose the invention, including the best mode, and also to enable any person skilled in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference. It is to be expressly understood, however, that each of the figures is provided for the purpose of illustration and description only and is not intended as a definition of the limits of the present invention. By way of non-limiting illustration, examples of certain embodiments of the present disclosure are given below.

### EXAMPLES

Materials and Methods: Five samples of sodium alginate powder were obtained for testing. All laboratory “glassware” coming in contact with any chemical used in this work has been made from polypropylene or Teflon thereby removing any possible ion contamination coming from glass equipment, typically made from borosilicate which contains leachable amounts of sodium, potassium and other ions. Only deionized water was used with a measured resistance in excess of 18 MOhm (<55 micro-Siemens).

In order to measure the amount of free Ca²⁺ ions which have reacted with the alginate, a Calcium Ion Selective Electrode (ISE) from Hanna Instruments Australia was used. The ISE is composed of the ion selective membrane, an internal reference electrode and an external reference electrode, all immersed in the sample solution to be measured (NICO 2000, 2014).

Reference Electrode: For a stable reading, a liquid-metal interface is used on either side of the membrane. The function of the external reference electrode is to provide this interface on the other side of the membrane to the internal reference electrode. The electrode provides a constant potential, which is eliminated from the reading during calibration.

Temperature Probe: A temperature probe was used to ensure experiments were being carried out at similar temperatures and for compensation of pH (this was done automatically through the software).

Bench Meter: The ISE, pH electrode, and temperature probe were all connected to the HI 4212 pH/mV/ISE/Temperature Bench Meter from Hanna Instruments Australia which gave simultaneous real-time readings.

General Experimental Methods: The Calcium ISE Meter was calibrated with 1000 ppm and 100 ppm calcium solutions. Alginate solutions (usually 1% by weight) were prepared fresh (on the day of measurement excluding stability trials) in solution (usually deionized water) by vigorous stirring and shaking until all the powder had dissolved.

The standard typical method for each trial was as follows. First, 30 mL of 300 ppm calcium solution in deionized water (or calcium plus other ions or a different calcium concentration) was added to a 50 mL plastic beaker using air displacement pipettes. Then 0.6 mL (2% w/w) of ionic strength adjuster (ISA) was added to the 30 mL calcium solution in the beaker. The ISA maintains the overall ionic strength of the solution as changing ionic strength (as when Ca is complexed or precipitated) can cause drift in the ISE meter readings. The beaker was placed on a magnetic stirrer (along with a submerged Teflon magnetic stirrer bar) and the ISE half-cell, reference electrode, and temperature probe (connected to the bench meter) were submerged in the ionic solution. The bench meter recorded the values of calcium each second. Finally, 1 mL aliquot of 1 wt % sodium alginate solution was added to the calcium solution. Once the meter reading had stabilized, the calcium value (free calcium ions in solution) was recorded. This process was repeated until 20 mL of sodium alginate solution had been added.

### Example 1. Studies of Unadulterated Alginates

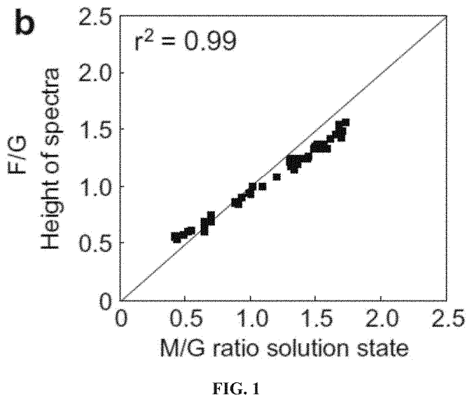

Alginate Structure: Recently methods for alginate structure determination using solid state NMR have been developed. These methods have the advantage of giving similar results as to solution NMR data but can be run on the alginate powder with no further sample preparation required. FIG. 1 shows the correlation of the results of solution and solid-state NMR showing the high degree of correlation of alginate structure determination between the two techniques. The ratio of M to G blocks can easily be determined by measuring the relative heights of the F and G bands obtained from the solid-state NMR spectra. The ratio of M and G blocks for all five studied alginates are given in Table 1. The two alginates with the highest proportion of G blocks in the alginate structure are alginates 3 and 4.

TABLE 1
shows relative amounts and ratio of M and G units determined
from the solid state NMR work conducted in this study.
Note the desirable high “G” ratio in alginates 3 and 4.

| | Sample 1 | Sample 2 | Sample 3 | Sample 4 | Sample 5 |
|---|---|---|---|---|---|
| F/G Band Ratio | 1.40 | 1.42 | 0.51 | 0.70 | 1.46 |
| G % | 42 | 41 | 66 | 59 | 41 |
| M % | 58 | 59 | 34 | 41 | 59 |

Rheology: Experiments were performed to determine the flow curves and yield stresses of the 5 different alginate samples at various concentrations and temperatures. The results here will focus on alginates 3, 4, and 5 being the low, mid and high viscosity products. The apparatus used for the rheology experiments was a Discovery Hybrid Rheometer (DHR-3) from TA Instruments. The following samples were prepared for rheology analysis (Table 2).

TABLE 2
shows experimental matrix for rheology experiments.

| Exp. Conditions | Alginate 3 | Alginate 4 | Alginate 5 |
|---|---|---|---|
| 1% w/w | X | X | X |
| 1% w/w plus Ca | X | X | X |
| 0.1% w/w | X | X | X |
| 0.1% w/w plus Ca | X | X | X |
| 0.01% w/w | | X | X |
| 0.01% w/w plus Ca | | X | X |

The flow curves of each of the 16 samples were tested using a cup and bob geometry, with a 500 s−1 pre-shear step, and viscosity measured over a shear rate range of 10 to 1000 s⁻¹ (or as high as possible if this could not be reached). Experiments were repeated at 4, 20, 40, and 60° C. The yield stresses of the 16 samples were measured using vane blade geometry, with a preshear step of 500 s−1 and a 3-hour shut-in at 2% oscillations. Measurements were only performed at 4° C.

Flow Curves: The viscosities were measured at changing shear rates between 10 and 1000 s−1 at temperatures of 4° C., 20° C., 40° C., and 60° C. for different concentrations of Alginates 3, 4, and 5. Viscosities for solutions of 0.1 wt % and below were very low (below 20 cP for sodium alginate, and inconclusive for calcium alginate solutions).

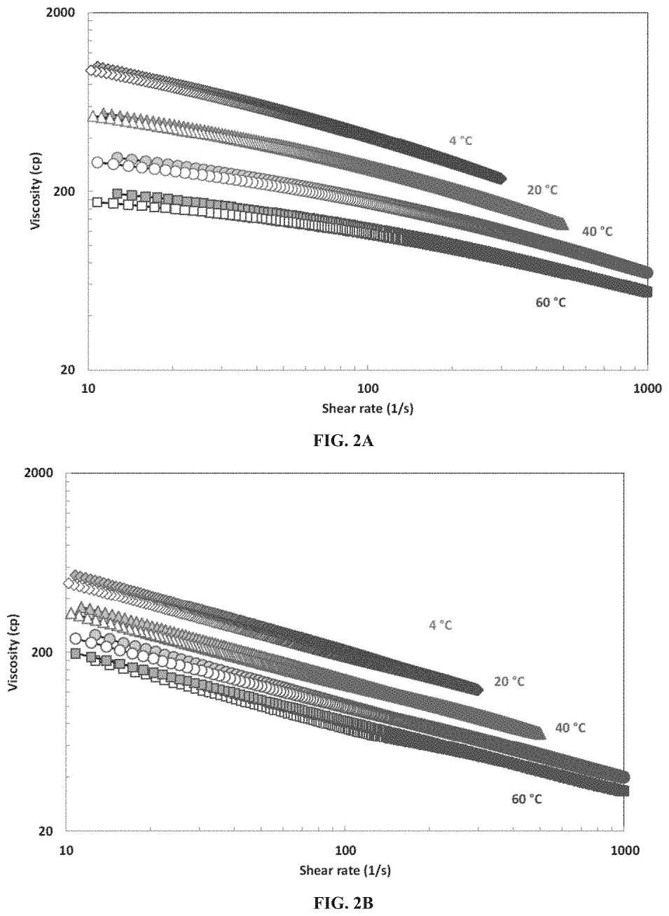

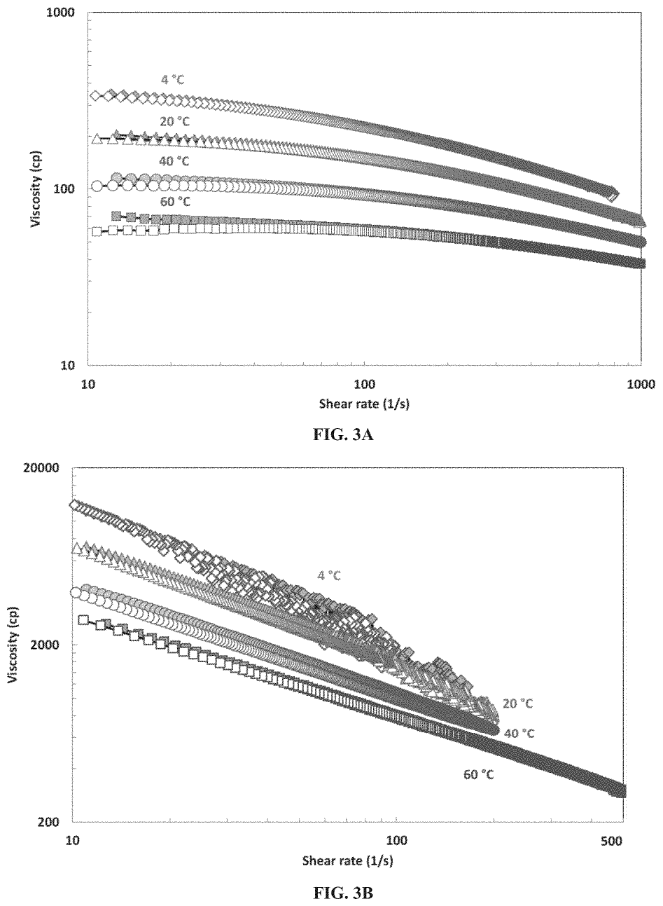

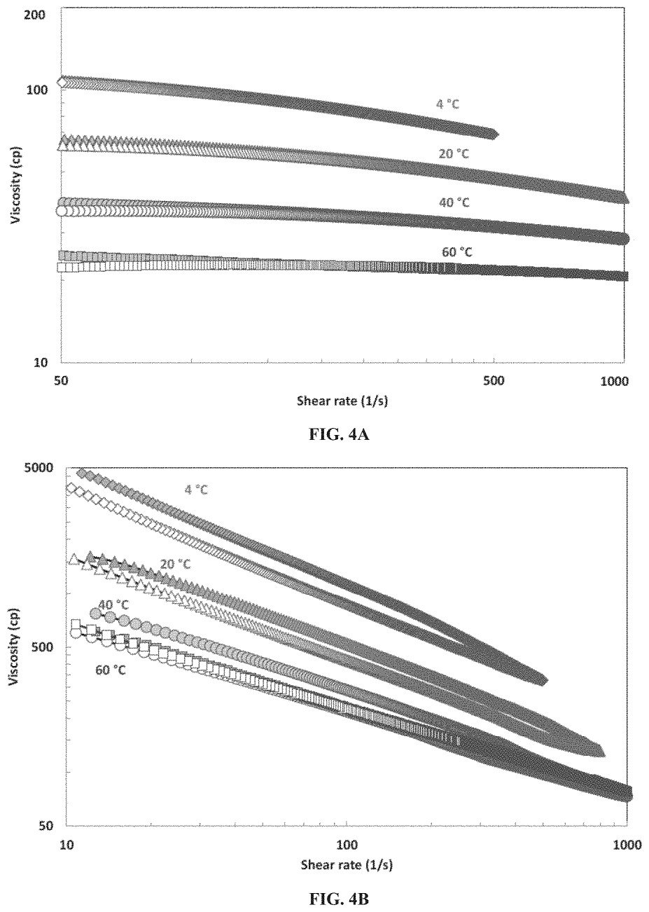

Viscosities for 1 wt % solutions of alginate in both pure water and calcium solutions are shown in FIGS. 2A, 2B, 3A, 3B, 4A, and 4B.

Sodium Alginate in Pure Water: The viscosity of Alginate 5 appears to decrease with increasing shear rate, showing the expected pseudo plasticity of the substance. The behavior of Alginates 3 and 4 however, seem to be more Newtonian. This may be because Alginate 5 has much higher values of viscosity than the other 2 samples. It may be that below a certain viscosity the shear will stop having much effect (perhaps around 100 cP). In pure water alginate 5 shows the highest viscosities, followed by samples 4 and then 3. This result is as expected as high G/M ratios should also display better binding ability with Ca²⁺ ions and is desirable.

Sodium Alginate in Calcium Solution: The behavior of all the samples after bonding with calcium appeared to be shear thinning. Again, this may be due to the fact that the values of viscosities for Alginates 3 and 4 have increased that the shear thinning behavior has become apparent. The viscosities of Alginates 3 and 4 both greatly increased after bonding with calcium, while Alginate 5 experienced a small decrease.

Temperature Dependence: The viscosity of all samples consistently increased with decreasing temperature. There is significant change between 60° C. and 4° C. and this will affect the flow in the pipe. In order to show how this will relate to the gas pipeline we can take Sample 3 as an example. At the injection point, there will be high temperature and no binding with calcium will have taken place so the viscosity will be very low (around 20 cP). As the alginate moves along the pipeline, it will bind with the Ca²⁺ ions in produced water and the temperature will decrease to around 4° C., increasing the viscosity to around 5000 cP (if we assume low shear rates, it would be 500 cP at high shear rates). This means the viscosity of this alginate has the potential to increase 250 times as it moves through the pipeline (and is 167 times greater than the pure MEG viscosity).

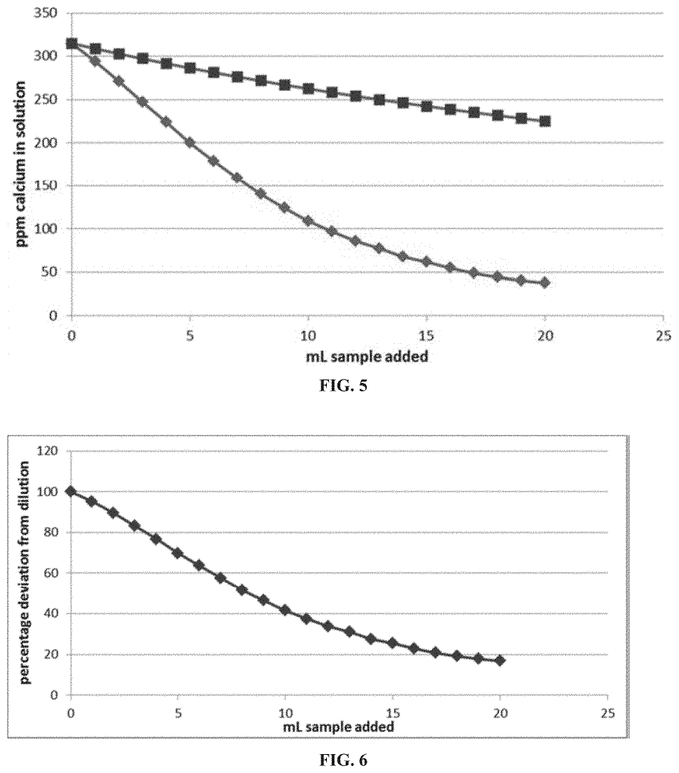

Calcium Binding: All the graphs and data presented in the following sections unless stated explicitly are dilution corrected. Firstly, as the alginate is added in solution, 1 mL aliquots into the 30 mL ionic solution, the concentration of calcium will slowly decrease regardless of any action of the alginates. Secondly, solutions cannot be made up to the exact same starting concentrations every time. Therefore, all the data was corrected for this dilution effect and was presented as a percentage deviation from the diluted value at any particular volume. Therefore, the graphs show how much calcium, as a percentage, has been removed from solution purely due to the effect of alginate addition as shown in FIGS. 5 and 6.

Calcium Binding Efficiency of Alginates: To determine the ability of alginates to bind calcium, preliminary experiments were conducted to test the ability of all five alginates to complex calcium ions and remove them from solution. One weight percent alginate solutions in water were freshly prepared and then added to 300 ppm calcium ion solutions (at neutral pH) through a series of 1 mL aliquots as described earlier in the General Experimental section. The results are presented in FIG. 7.

FIG. 7 shows that Alginates 1 and 2 perform similarly while alginate 5 shows the least affinity for calcium. However, Alginates 4 and especially 3 show a much higher complexation affinity for the calcium ions. These results are in line with the fact that Alginates 3 and 4 have the highest “G” amount in the alginate polymer followed by 1, 2, and 5. These results indicate that alginates 3 and 4 are the highest performing alginates.

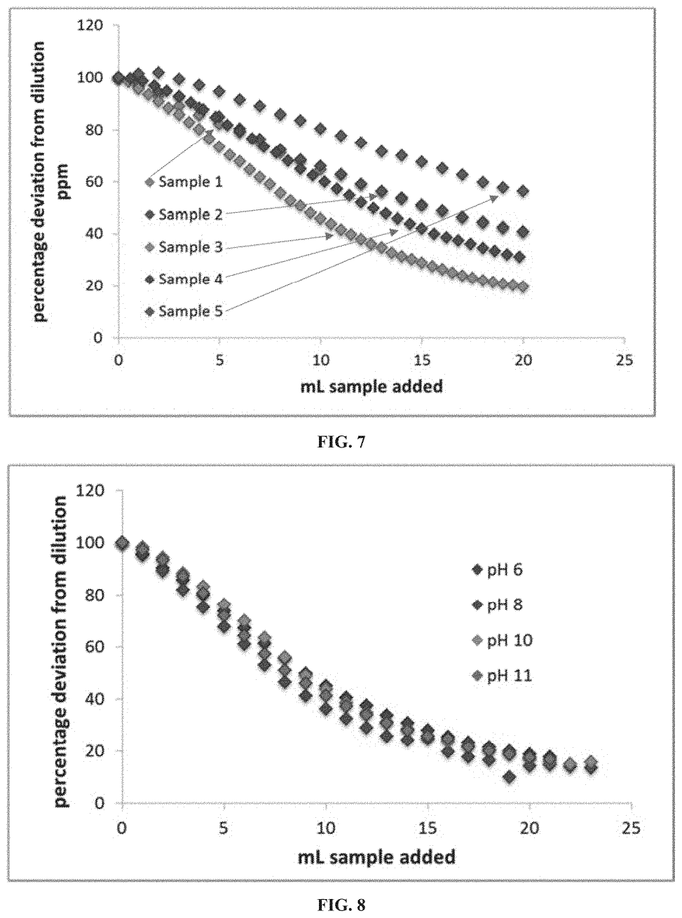

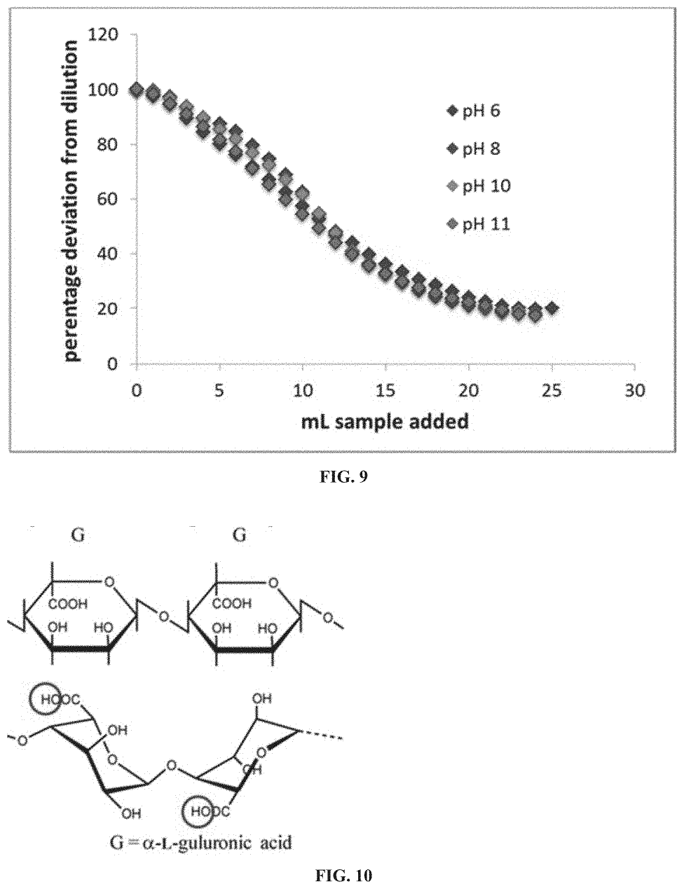

Effect of pH: As the aim of the corrosion passivation is through pH control, experiments were run with alginates 3 and 4 to determine their effectiveness at different pH's from 6 to 11. This was conducted by adding neutral alginate aliquots to 300 ppm calcium ion solution at different pH values. The results are shown in FIGS. 8 and 9. pH has no effect on the calcium binding ability of either of the alginates. This is to be expected as the pKa of the calcium binding Guluronic “G” acidic hydrogens is approximately 3.7 so any pH above 4 should have the “G” gully ionized and therefore ably to bind with calcium. The acidic protons on the “G” is shown in FIG. 10.

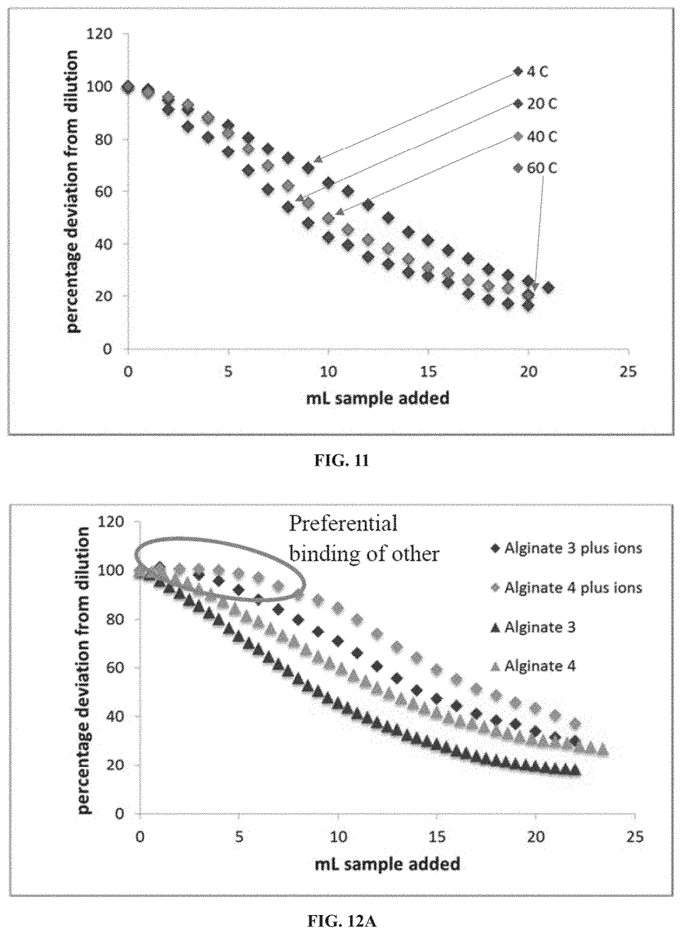

Effect of Temperature: The effect of temperature was measured by heating or cooling the beaker containing the calcium ion solution. The alginate solution added was at room temperature. This series of experiments had an upper limit of 60° C. as this was the maximum working temperature of the ion selective probe. As can been seen in FIG. 11, decreasing temperature produced a small but noticeable decrease in the calcium binding of the alginate for similar volumes added. The addition of alginate would overcome this effect and produce similar overall reduction in calcium.

Complexation with competitive Ions: The effect of competing cations on alginate ability to complex calcium ions was measured. Taking a produced water sample as a guide to ion concentrations, a series of experiments were conducted. Based on these values, a series of experiments were conducted to measure the effect of competing ions. All measurements were conducted at ambient temperature and conducted in a similar manner as previous experiments. The cations used in these and subsequent experiments were prepared from the salts in Table 3.

TABLE 3
Salts used to prepare
ionic solutions

| Ion | Salt |
|---|---|
| Na⁺ | NaCl |
| K⁺ | KCl |
| Ca²+ | CaCl₂ |
| Mg²⁺ | MgCl₂•6H₂O |
| Fe²⁺ | FeSO₄•7H₂O |
| Sr²⁺ | SrCl₂•6H₂) |
| Ba²⁺ | BaCl₂•2H₂) |

The results are discussed below. Once again, the vertical axis of the graphs show the percentage deviation from dilution compared to the starting solution of approximately 300 ppm. Diamonds represent the current experimental values measures in the presence of the other ions in the experiment. Triangles represent a base case of calcium extraction from a pure solution of 300 ppm calcium in water.

Addition of Divalent Ions Magnesium, Strontium, Barium to Calcium: The objective of this experiment was to determine the effect of other divalent ions on the ability for the alginates to complex calcium.

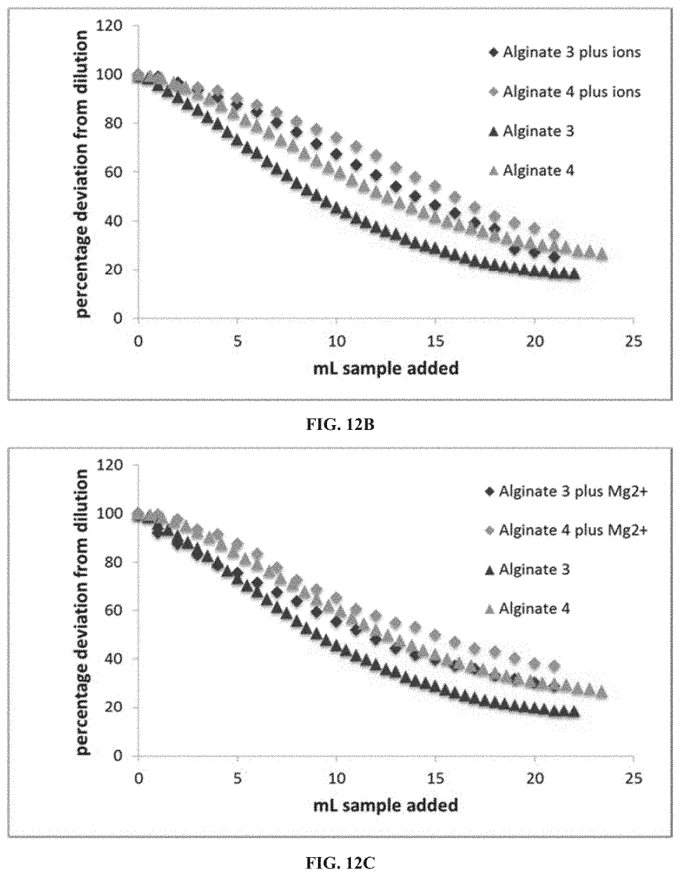

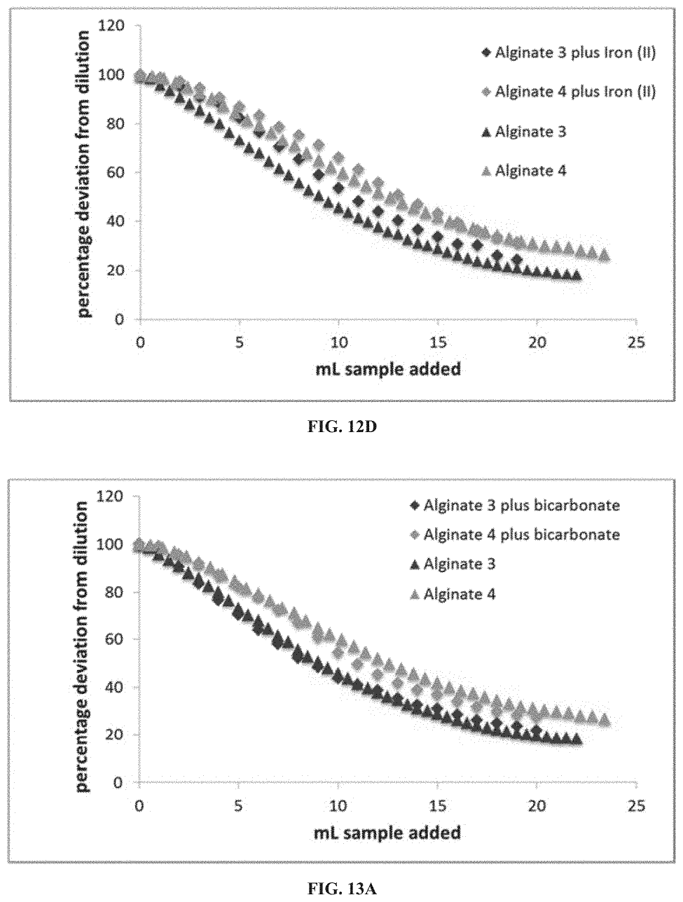

As seen in FIG. 12A, the presence of divalent ions in approximate concentrations expected in the produced water had a small but noticeable effect on the calcium uptake from the alginates. The presence of these ions reduced the efficacy of the alginate by approximately 10% with Alginate 3 being more efficient than Alginate 4 (as expected). It is worth noting that as more alginate was added the difference between the base alginate data and the alginate plus ions data decreased, indicating that in the presence of excess alginate the effect of the divalent ions is reduced. This is probably due to the alginates preferentially binding to the other ions before calcium. This is most evident in the early stage of the experiments where the base case shows an initial decrease in the calcium concentration upon addition of the alginate whereas there is a delayed action in the analogous experiment with the divalent ions present.

Addition of Monovalent and Divalent Ions Potassium, Magnesium, Strontium, Barium to Calcium: This experiment was to determined the effect of other mono- and divalent ions on the ability for the alginates to complex calcium. Sodium was not included in this study as the high concentration (8000 ppm) interfered with the calcium probe and gave spurious readings.

FIG. 12B demonstrates similar behavior as the previous experiment showing a small decrease in efficacy due to preferential binding of some of the divalent ions, with the effect reducing as more alginate is added. The additional presence of the potassium appears to have no effect on the alginate's calcium binding ability.

Addition of Magnesium to Calcium in solution: This experiment was to determine the effect of high levels of magnesium on the ability of alginate to complex calcium.

To observe the effect of magnesium ions on alginate calcium binding, a 1:1 (300 ppm) solution of Ca²⁺ and Mg²⁺ ions was prepared. FIG. 12C shows a small but persisting effect due to the presence of magnesium 2+ ions. This is assumed to be from preferential binding of the magnesium ions to some of the sites on the alginate. It is worth noting that while there is a small effect, significant amounts of calcium are still removed from solution. This shows that even though there might be some binding of magnesium, it is not at the exclusion of calcium.

Addition of Iron (II) to calcium in solution: This experiment was to determine the effect of iron (Fe²⁺) on calcium extraction and show if there was any preferential binding of Fe over Ca. A solution of 300 ppm Ca²⁺ and 300 ppm Fe²⁺ was used.

To determine the effect of iron (II) ions on alginate calcium binding, a 1:1 (300 ppm) solution of Ca²⁺ and Fe²⁺ ions was prepared. FIG. 12D shows very little effect if any due to the presence of iron (II). At the much lower levels expected in the produced water, this data indicates that the presence of any iron (II) will have no detrimental effect.

Effect of Bicarbonate on Calcium Complexation: In previous experiments, the uptake of calcium by alginates was shown to be effective and not detrimentally affected by temperature, pH (>4.5), and the presence of other cations, especially divalent cations such as Mg, Ba, Sr. In this series of experiments, the effect of bicarbonate ion was measured on calcium complexation by alginate. This was measured by two types of experiments. As usual, two alginates were used, Alginate 3 and 4. These were chosen as they had demonstrated the most efficacy in calcium binding in previous experiments with Alginate 3 performing the best (also the alginate with the highest percentage of “G” residues in the alginate polymer structure).

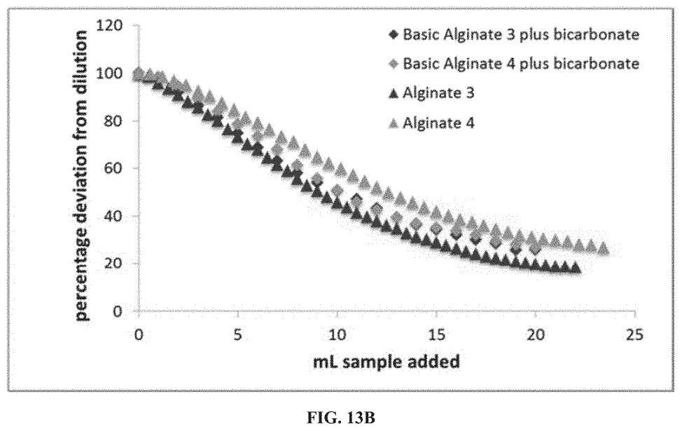

The first experiment was conducted with the receiving beaker containing 300 ppm calcium (as calcium chloride) and 1350 ppm bicarbonate (as the sodium salt). These values were chosen as they are representative of the amounts of these ions in the produced water sample. This solution in the beaker was at its natural pH. Aliquots of 1% w/w alginate (dissolved in water at neutral pH) was added to the receiving beaker and the calcium concentration noted. The experiment was conducted until 20 mL of alginate solution was added. The results are shown in FIG. 13A which demonstrates that at its natural pH (both the ion solution and the added alginate) the bicarbonate (diamond symbols) does not have a detrimental effect and the data is very similar to that of just alginate and calcium (the triangle symbols). As usual, Alginate 3 performed better than Alginate 4 (due to its higher “G” content).

A second similar experiment was conducted with the receiving beaker containing 300 ppm Ca and 1350 ppm bicarbonate at a neutral pH. The alginate solution was prepared in pH 10 water (pH achieved by addition of NaOH) so as to replicate the proposed dosage system where the alginate would be added in a basic solution. The results are shown in FIG. 13B.

The results are very similar to those at neutral pH and those without bicarbonate present. The data shows that the presence of bicarbonate did not have a detrimental effect on the calcium binding whether the alginate was in a neutral or basic solution.

Carbonate Precipitation: Experimental data on the addition of basic alginate to calcium solutions containing bicarbonate indicates that the alginate complexed with the calcium and no calcium carbonate solid was formed. Further experiments were conducted to look for evidence of precipitate formation.

The first experiment involved the addition of pH 12 water to a pH neutral solution containing 300 ppm calcium ions and 1350 ppm bicarbonate ions. After the addition of 4, 1 mL aliquots of basic water, the solution containing the ions started to go cloudy and further addition of basic water increased the cloudiness.

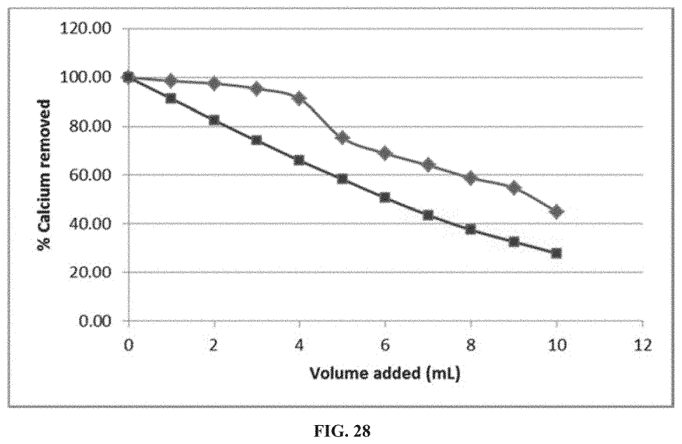

A second experiment was conducted where aliquots of pH 12 alginate solution (1% w/w Alginate 3) were added to a pH neutral solution containing 300 ppm calcium ions and 1350 ppm bicarbonate ions. In this experiment the calcium concentration decreased but no cloudiness was observed. The two titration curves are presented in FIG. 28.

To confirm the presence or absence of precipitate formed in the two experiments, both samples were centrifuged at 1500× gravity for 2× five minute intervals. Precipitate formed in the first experiment where basic water was added to the calcium and bicarbonate ion solution. The solid is presumed to be calcium carbonate. However, there was no evidence of any precipitate formed in the second experiment where alginate solution was added to calcium and bicarbonate ion solution. As the calcium concentration decreased with the addition of alginate to the ionic solution (squares, FIG. 28) this indicates that the calcium was preferentially bound by the alginate and not available for precipitation in calcium carbonate.

Dosing Optimization

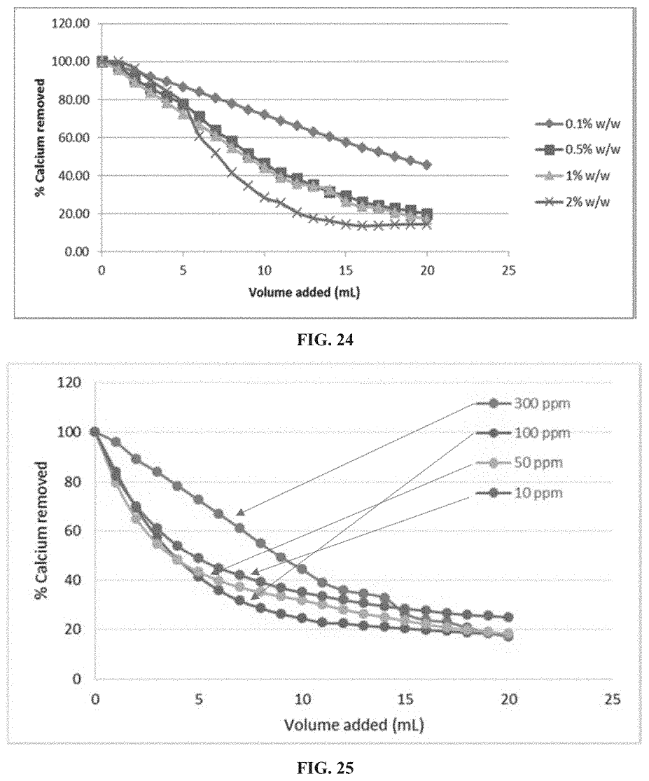

Alginate Concentrations: To determine the minimum concentration of alginate required to be effective, a series of titrations were conducted with differing concentrations of alginate solution titrated against 300 ppm of calcium at neutral conditions. The results are shown in FIG. 24. It can quickly be noted that the 2, 1, and 0.5% solutions all converge at the same level of complexation after 20×1 mL aliquots. The 0.1% solution is still decreasing and would probably arrive at the same value if another 10-15 mL were added. These results suggest that as long as there is enough alginate available to bind with the calcium, the dosage concentration is not important.

Another major outcome from this and all previous experiments is that no matter the conditions (e.g., concentrations of reactants), in relative terms the experiments all plateau at just under 80% calcium removal, or with 16-18% of the calcium still in solution. This suggests that some equilibrium between bound and unbound calcium exists stopping lower values to be obtained. This phenomenon is explored in the following two sections.

Calcium Concentrations: To study this equilibrium phenomenon further, a series of experiments were conducted with 1% alginate solutions being titrated against calcium solutions of 300, 100, 50, and 10 ppm. The results are shown in FIG. 25. As it can be seen, all of the titrations finish with slightly less than 20% of the original calcium still being in solution. This confirms that there is an equilibrium forming between the gel and solution, regardless of the absolute calcium concentrations involved. This can be further elucidated through the following: 30 mL of the 10 ppm solution contains a total of 0.25 mg of calcium. The addition of 1 mL of 1% alginate removes 0.63 mg of calcium when titrated against a 300 ppm solution. Therefore, the addition of 1 mL of 1% alginate should remove all of the calcium in a 10 ppm solution. However, it doesn't and the shape of the titration curve follows the other curves from different calcium concentrations.

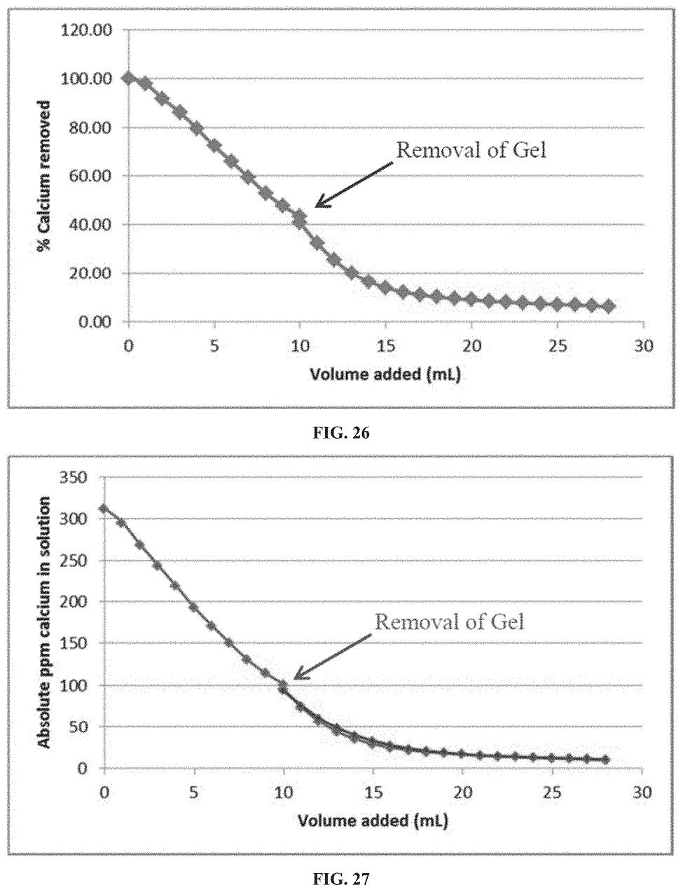

A further set of experiments was conducted where the alginate gel formed was removed part of the way through a titration. The idea being that if the gelated calcium was removed and then more alginate solution added, the calcium curve should behave like a fresh solution and not exhibit the equilibrium behavior. The experiment was conducted as follows. A standard titration was conducted with a 1% Alginate 3 solution against a 300 ppm calcium solution. After the addition of 10 mL of alginate (and 101 ppm calcium remaining in solution), the solution was filtered through a tea strainer and the alginate gel removed from the solution. The remaining solution (30 mL) was measured to have a calcium concentration of 96 ppm. A further 20, 1 mL aliquots of alginate was titrated against the remaining solution. The dilution corrected titration curve is shown in FIG. 26. A normal titration of a 300 ppm calcium solution against a 1% Alginate 3 solution would result in a 20% residual calcium concentration (or 30 ppm) after the addition of 20 mL. However, with the alginate gel being removed after the addition of 10 mL, the resulting solution had a concentration of 100 ppm. Further addition of alginate followed a typical pattern for a 100 ppm experiment rather than a 300 ppm experiment with a final calcium concentration of 6 ppm (18%) of the starting 100 ppm when the gel was removed. FIG. 27 shows a comparison of the experiment where the gel was removed at 100 ppm, and a normal 100 ppm titration. The curves overlay each other indicating it was the presence of the calcium gel that was buffering the system at 18-20% residual calcium in solution. Lower calcium values could be achieved if more gel was removed in the latter stages of the experiment, achieving a sub ppm level of calcium in solution.

In a flowing system such as a pipeline, calcium/alginate gel would separate from the residual liquid during flow due to slower transport speeds thereby acting in a similar way to this experiment indicating that the alginate could achieve very high efficiency in a flowing system.

Thermal Stability

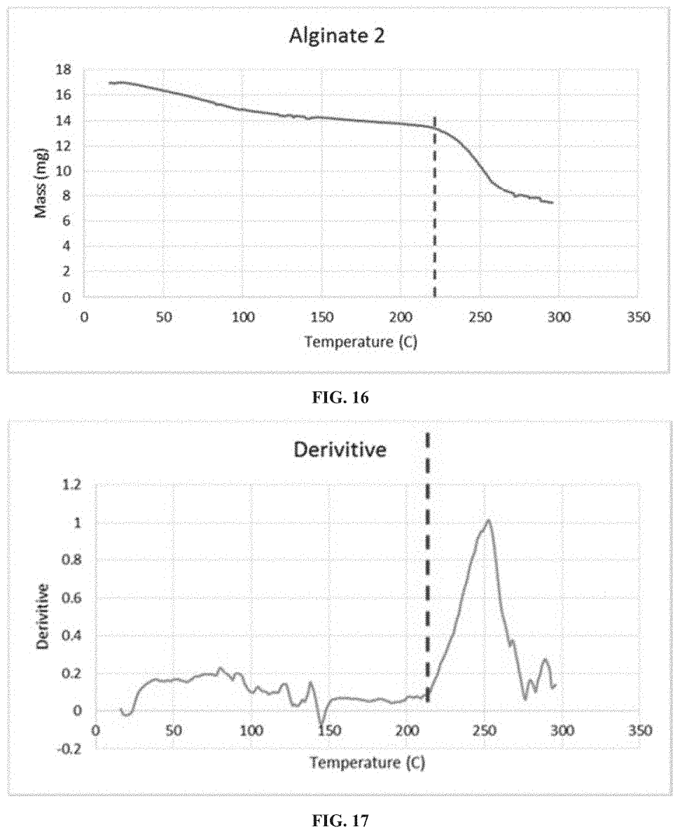

Solids: Experiments were conducted to determine the temperature at which the alginate powder (sodium alginate) would degrade, thereby determining the theoretical maximum temperature the alginate could be exposed to. Thermal degradation experiments were conducted in a thermogravimetric analyzer (TGA) as this afforded the ability to measure mass lost with increasing temperature while being able to control the surrounding atmosphere. A typical experiment included loading 10-50 mg of alginate powder onto a platinum pan and loading it into the TGA. A surrounding atmosphere of argon was chosen as this would prevent oxidation of the alginate and thereby only thermal degradation would occur. The alginate sample was then heated at 10° C./min to a temperature of 300° C. The mass of the alginate was constantly recorded. The degradation temperature could be determined by a large loss in mass at a set temperature as shown in FIG. 16. The alginate (sodium salt) degrades to sodium carbonate and a carbonized material along with the loss of gaseous CO₂ and H₂O. The degradation temperature can more easily be seen in FIG. 17, which is the derivative of FIG. 16 highlighting the temperature at which mass loss occurs.

All five alginates showed similar behavior with degradation temperatures of approximately 220° C. Therefore, 220° C. is the maximum theoretical temperature the alginates can be exposed to before they degrade.

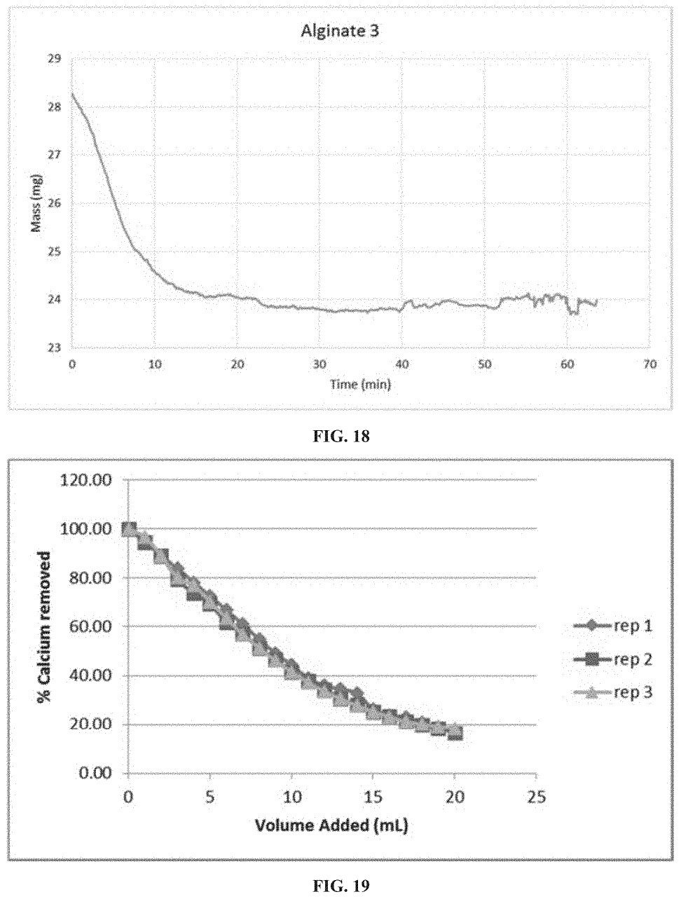

To determine the stability of the alginate powder at elevated temperature, a further TGA experiment was conducted where the alginate sample was held at 150° C. for 60 minutes in an inert argon atmosphere. The data is shown in FIG. 18. As can be seen there is no mass lost after 20 minutes (150° C.) indicating the alginate powder is thermally stable. The mass lost from 0 to 20 minutes is due to moisture loss from the sample.

At temperatures in excess of the degradation temperature (approx. 220° C.), the alginate powder decomposes into a “fluffy” expanded mass. This behavior is common for organic acids, alginate being a polymer of organic acid units.

Solutions: A series of experiments were conducted on alginate solutions studying the stability over three weeks at room temperature, room temperature at high pH, at 80° C. and at 160° C. The results are below.

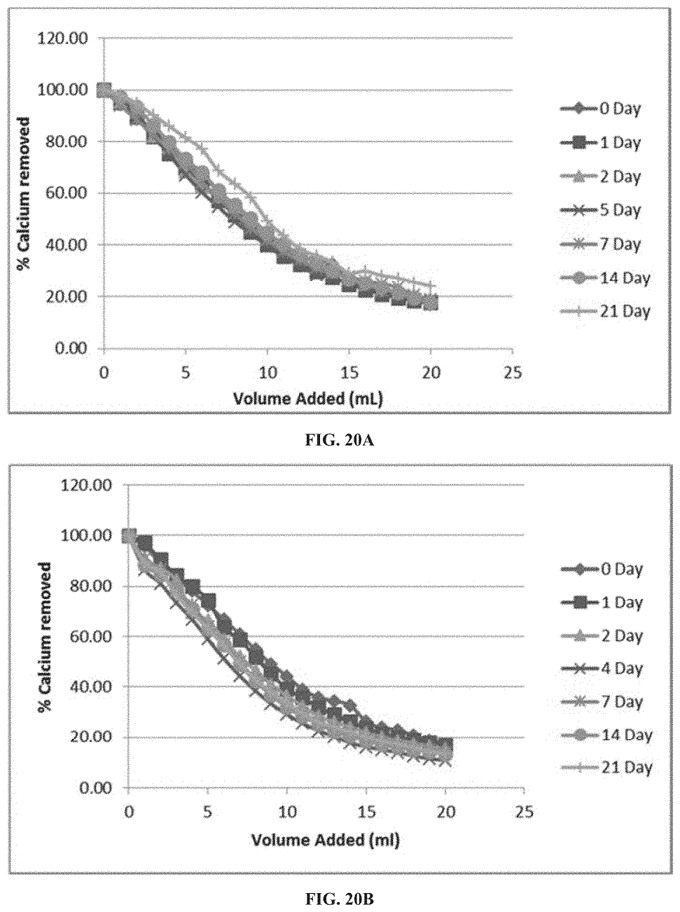

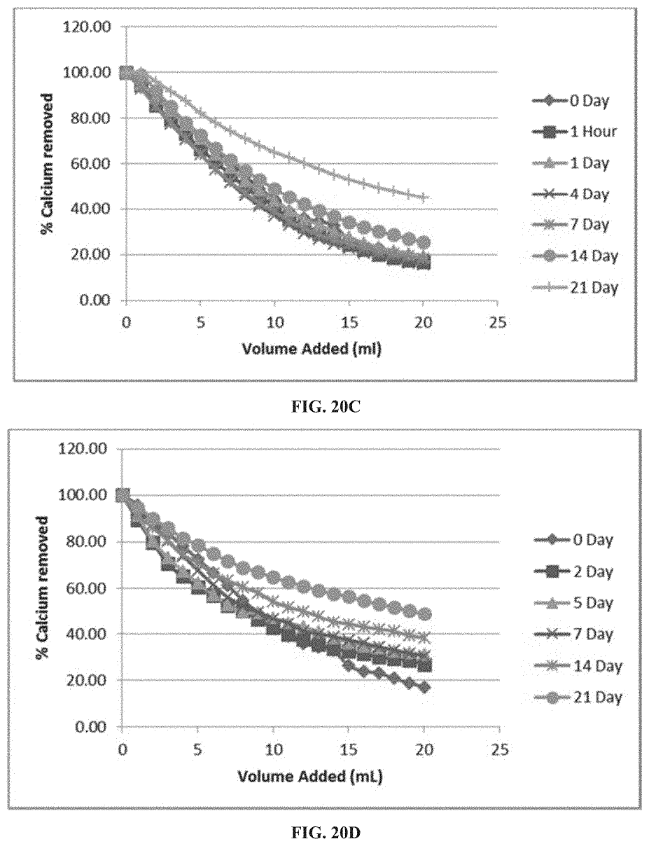

Room Temperature: Solutions of 1% w/w of Alginate 3 in deionized water were prepared and stored in a dark cupboard. Samples were taken at 0, 1 2, 5, 7, 14, and 21 days and the efficacy at calcium complexation was measured in standard experiments. In addition, a series of baseline reproducibility experiments were conducted, and the results are shown in FIG. 19. As can be seen, the alginate complexation titrations are very reproducible, therefore any variations in the following data are real effects of the stability trials and not due to natural experimental variations. FIG. 20A shows the efficacy of the alginate solution over 21 days. As can be seen, there is a very small decrease over the first two weeks with the decrease a little more noticeable for the 21-day sample.

Room temperature and pH 12: Stability trials were conducted in a similar fashion as the previous room temperature trials except the alginate solutions were made in pH 12 water. The plots in FIG. 20B show a slight increase in efficacy over the first week followed by a slight decrease in weeks two and three. Overall there is no substantial change over the 21 days.

80° C.: A series of Alginate 3 solutions (1% w/w, neutral pH) were prepared in and placed in sealed polypropylene tubes and placed in an isothermal oven at 80° C. At regular intervals over three weeks, a tube was removed, allowed to cool to room temperature, and then titrated against a 300 ppm solution of calcium. The results are presented in FIG. 20C.

As can be seen in FIG. 20° C., after 7 days (the 14- and 21-day samples), the efficacy reduces by a significant amount, especially the 21-day sample. Looking at the samples retrieved the 14- and 21-day samples started to go a light shade of brown. This probably indicates thermal degradation as seen in the solids work discussed previously.

160° C.: A series of Alginate 3 solutions (1% w/w, neutral pH) were prepared in and placed in sealed Teflon containers mounted in steel containers rated to 30 bar. These were placed in an isothermal oven at 160° C. At regular intervals over three weeks, a tube was removed, allowed to cool to room temperature, and then titrated against a 300 ppm solution of calcium. The results are presented in FIG. 20D.

As can be seen in FIG. 20D, alginate efficacy has decreased in every sample indicating that the alginate was degrading continuously at 160° C. After 21 days, the alginate's ability to bind calcium had nearly halved based on similar volumes of added alginate. Furthermore, the solutions had turned a very dark brown color and smelled like “burnt caramel”.

During the titrations it was noted that the brown degraded liquid possessed much better flow properties than the “normal” alginate. While the normal 1% w/w solution was quite viscous the brown alginate liquid displayed flow behaviors very similar to water. Furthermore, when an aliquot of normal alginate solution was added to a calcium solution, it would take a few seconds for the calcium concentration to start to decrease and then tens of seconds for the new lower value to stabilize. When an aliquot of the brown thermally degraded solution was added to a calcium solution, the calcium concentration instantly decreased to the final value, indicating that the degraded alginate had much faster kinetics of complexation.

Another major point of interest was the structure of the calcium alginate complex formed during the titration. When the traditional alginate solution is added to a calcium solution, a gel forms and the more calcium in solution, the tighter the gel. This gel also binds a lot of water in the gel matrix leading to a solid gelatinous mass to be formed with high enough calcium and alginate concentrations.

When the brown alginate liquor is used to bind calcium in a normal titration, a gel is not formed. Instead, small brown platelets are formed that include the alginate and calcium. These platelets do not bind up the excess water allowing these platelets to easily flow in solution.

This platelet type structure of the calcium alginate complex could be beneficial in the overall pipeline management strategy. Unlike the thick gels that can form when unadulterated alginates are used, these platelets do not qualitatively increase the viscosity, do not form large gels, do not bind up the free water and settle quickly under gravity, thereby allowing for gravity separation techniques to be employed in the gas processing facility to remove the calcium complex.

### Example 2. Studies on Thermally Degraded Alginates

Thermal degradation studies were conducted on the solid alginate powder to determine if the same advantageous product could be formed, since the thermally degraded alginate solution still bound calcium and displayed advantageous properties.

Alginate 3 powder in an open container was placed in an oven at 180° C. for 24 hours. The solid was then removed and allowed to cool. The solid had turned a brown color but had similar structural properties as the unadulterated powder.

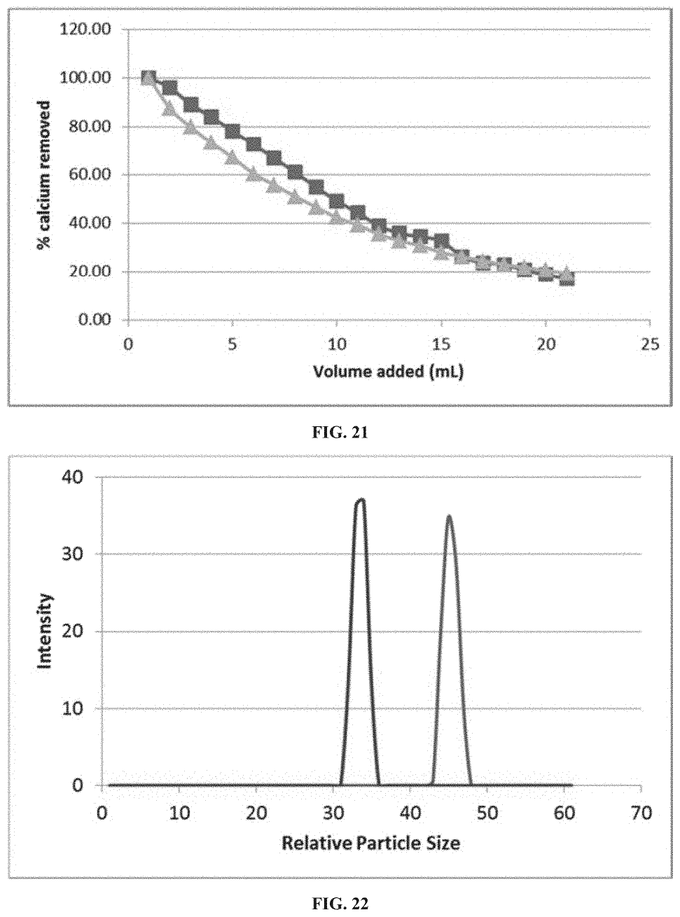

A 1% w/w solution of the brown alginate powder was made in water and titrated against a 300 ppm calcium solution as standard and the resultant titration curve compared to a titration with unadulterated powder (FIG. 21). As can be seen, the two curves behave similarly and there is no difference in the overall efficacy after the addition of 20 mL of alginate solution.

Particle Size Analysis of Alginates: Dynamic light scattering particle sizing was conducted on solutions of alginate 3 and thermally degraded alginate. FIG. 22 shows the averaged size distribution of these samples showing that the thermally degraded alginate has a particle diameter of 336 nm compared to 1725 nm for the unadulterated alginate. While these numbers are the average of the size distribution, visual analysis of FIG. 22 shows that the thermal degradation has reduced the alginates to approximately 20% of the original size.

Solubility of Alginates: Whilst conducting these experiments it was noticed that the brown alginate powder dissolved in the water very quickly, a matter of seconds, vs minutes with vigorous shaking for the normal powder. A series of solubility tests were conducted and a comparison of alginates and thermally degraded alginates is presented below in Table 4.

1% wt and 5% wt solutions of unadulterated alginate or thermally degraded alginate (activated at 160° C. for 24 hrs) were dissolved in water at ambient temperature (20-25° C.) under moderate stirring using a magnetic ‘flea’ stirrer. The thermally degraded alginate dissolved in <1 minute (essentially instantaneously) with no clumps of undissolved material. In contrast, the un-activated alginate to >1 hrs to fully dissolve and often displayed clumps of undissolved material which required vigorous agitation to dissolve fully.

TABLE 4
Solubility properties of natural and degraded alginate powder

| Unadulterated Alginate | Thermally Degraded Alginate |
|---|---|
| Forms Viscous Solutions | Forms low viscosity solutions |
| 5% w/w almost immobile gel | 5% w/w water like viscosity |
| Slow dissolution process | Very rapid dissolution |
| Slower binding of calcium | Rapid calcium binding |
| Forms crosslinked gels with calcium | Forms platelets with calcium |
| Gels contain entrained water | Gels do not entrain water |
| Insoluble in MEG | Insoluble in MEG |
| Sparingly soluble in 98:2 MEG:H₂O | 1% w/w soluble in 98:2 MEG:H₂O |

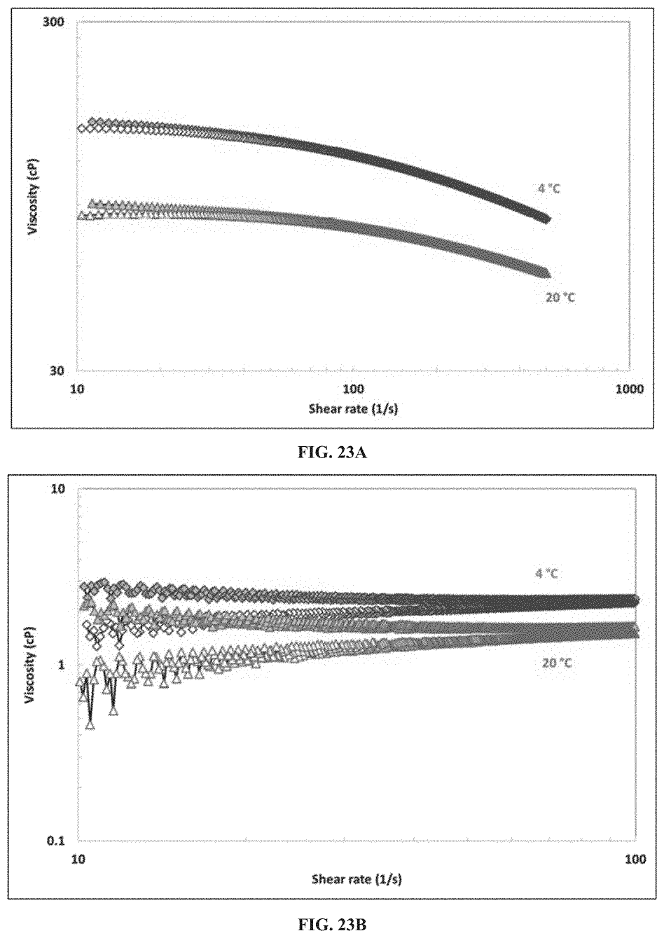

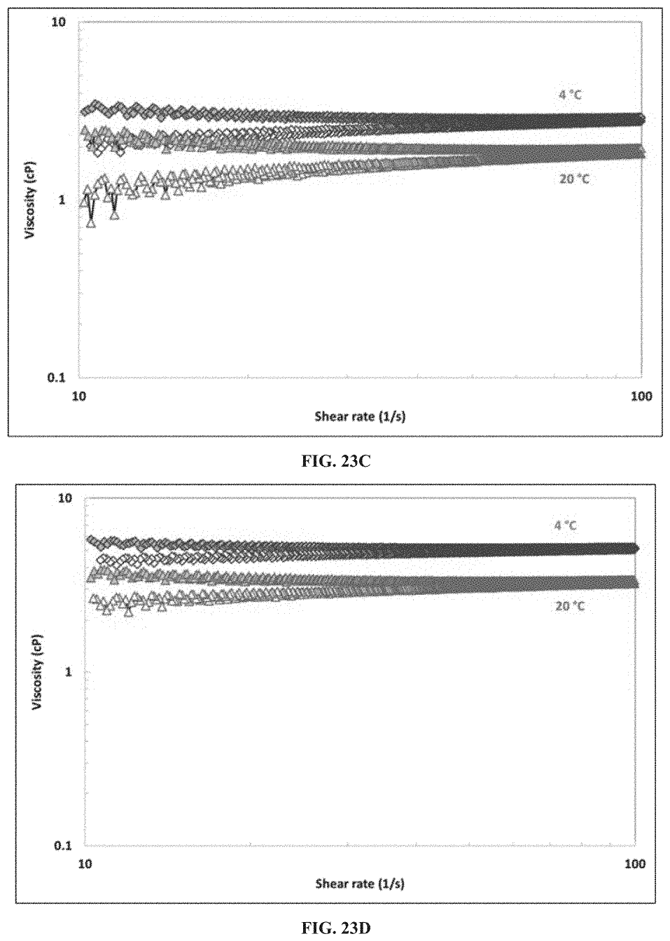

Rheology of Thermally Treated Alginate: Rheological studies were performed on the thermally degraded alginate (160° C. for 24 hours) under similar conditions as discussed in Example 2. Viscosity was measured at 4° C. and 20° C. for solutions containing 1% w/w Alginate 3, 1% w/w thermally degraded Alginate 3, 2% w/w thermally degraded Alginate 3, and 5% w/w thermally degraded Alginate 3. Shear rate ramping between 10 and 500 s−1 and back were conducted with a cup and bob geometry. FIGS. 23A to 23D visually show the rheological behavior.

It can be seen that the thermally degraded alginate has a much lower viscosity than the natural alginate solutions. In a direct comparison between the unadulterated and thermally degraded 1% solutions, the viscosity of the unadulterated solution decreases from 155 cP to 82 cP with increasing shear (shear thinning behavior) while the degraded solution shows no shear thinning and has a constant viscosity of ≈2.4 cP (40 to 60 times lower than the unadulterated sample). At 20° C., while both solutions show lower viscosities with the increased temperature, the unadulterated alginate solution still exhibits shear thinning and has viscosities decreasing from 90 cP (at shear 10 s−1) to 57 cP (at 500 s−1) while the degraded alginate shows a constant viscosity of 2.6 cP across all rates of shear.

Increasing the concentration of degraded alginate to 2 wt % and 5 wt % (FIGS. 23C and 23D) increased the viscosity of the solutions by a small degree but the solutions still did not display any shear thinning. A summary of the viscosity data is shown in Table 5.

TABLE 5
Viscosity data at the beginning (10 s-1) and end
(500 s-1) of the shear ramps for different alginate solutions.

| | 4° C. | | 20° C. | |
|---|---|---|---|---|
| | 10 s⁻¹ | 500 s⁻¹ | 10 s⁻¹ | 500 s⁻¹ |
| 1% Alginate | 155 cP | 82 cP | 90 cP | 57 cP |
| 1% Degraded | 2.4 cP | 2.4 cP | 1.9 cP | 1.6 cP |
| 2% Degraded | 3.2 cP | 2.9 cP | 2.3 cP | 1.9 cP |
| 5% Degraded | 5.6 cP | 5.2 cP | 3.5 cP | 3.3 cP |

Flow Experiments: Two types of flow experiments were conducted to determine the flow characteristics of alginate solutions through a nozzle and a 10 μm filter. The test apparatus included a constant flow pump (with selectable flowrates) attached to either a 10 μm filter or a 2 mm nozzle (10 mm long) at the end of a length of ¼″ piping. Various flow rates of water, 1% alginate, and 1% and 5% degraded alginate solutions were flowed through the apparatus. The results are shown in Tables 6-9.

TABLE 6
Flow data for pure water through various restricted flow scenarios

| Flowrate | Open tube | 2 mm Nozzle | 10 μm filter |
|---|---|---|---|
| (ml/min) | (Back Pressure, bar) | (Back Pressure, bar) | (Back Pressure, bar) |
| 1 | 0.4 | 0.4 | 0.5 |
| 2 | 0.4 | 0.4 | 0.7 |
| 5 | 0.4 | 0.4 | 1.2 |
| 10 | 0.5 | 0.5 | 2.0 |
| 25 | 0.5 | 0.5 | 4.1 |
| 50 | 0.8 | 0.6 | 8.0 |
| 100 | 0.9 | 0.7 | 16.6 |

TABLE 7
Flow data for 1% w/w Alginate solution
through various restricted flow scenarios

| Flowrate | Open tube | 2 mm Nozzle | 10 μm filter |
|---|---|---|---|
| (ml/min) | (Back Pressure, bar) | (Back Pressure, bar) | (Back Pressure, bar) |
| 1 | 0.6 | 0.6 | Pressure increases |
| 2 | 0.6 | 0.6 | slowly |
| 5 | 0.7 | 0.8 | regardless of the |
| 10 | 1.0 | 1.0 | flowrate |
| 25 | 1.4 | 1.4 | |
| 50 | 1.9 | 2.0 | |
| 100 | 2.8 | 2.9 | |

TABLE 8
Flow data for 1% w/w degraded Alginate solution through
various restricted flow Scenarios

| Flowrate | Open tube | 2 mm Nozzle | 10 μm filter |
|---|---|---|---|
| (ml/min) | (Back Pressure, bar) | (Back Pressure, bar) | (Back Pressure, bar) |
| 1 | 0.4 | 0.4 | Pressure increases |
| 2 | 0.4 | 0.4 | rapidly regardless of |
| 5 | 0.4 | 0.4 | the flowrate |
| 10 | 0.5 | 0.5 | |
| 25 | 0.5 | 0.5 | |
| 50 | 0.6 | 0.6 | |
| 100 | 0.8 | 0.8 | |

TABLE 9
Flow data for 5% w/w degraded Alginate solution
through various restricted flow scenarios

| Flowrate | Open tube | 2 mm Nozzle | 10 μm filter |
|---|---|---|---|
| (ml/min) | (Back Pressure, bar) | (Back Pressure, bar) | (Back Pressure, bar) |
| 1 | 0.4 | 0.4 | Pressure increases |
| 2 | 0.4 | 0.4 | rapidly regardless of |
| 5 | 0.5 | 0.4 | the flowrate |
| 10 | 0.5 | 0.5 | |
| 25 | 0.5 | 0.6 | |
| 50 | 0.6 | 0.6 | |
| 100 | 0.9 | 0.9 | |

There are two main conclusions from this flow work. First, the thermally degraded alginate solutions (1% w/w and 5% w/w) behave similarly to pure water, with only slightly higher back pressure values than pure water for the open and nozzle systems. The 1% alginate solution showed significantly higher values as observed when comparing the 100 mL/min nozzle results; 2.9 bar compared with 0.8 bar for the 1% degraded sample.

The second issue is that neither of the alginate solutions would pass through the 10 μm filter. The filter used was a VCR snubber gasket from Swagelok (#SS-4-VCR-2-10M). The rig was disassembled at the end of the experiment and the filter removed and examined. It was noted that there was a “blob” of alginate sitting on the inlet face of the filter indicating that the filter had blocked because the alginate has coated the entrance face of the filter. For the thermally treated alginate samples, there was no apparent “blob” however there was a light brown stain in the filter indicating that the alginate had clogged the filter. This is reasonable based on the physical properties known of the alginates and degraded alginates. The unadulterated alginates are significantly larger than the pore size of the filter and accumulated on the surface, blocking flow. The degraded alginate is much smaller and penetrated the filter and clogged it internally. Potentially, if the alginate was degraded to a smaller size it may flow through the filter without causing blockages.

### Example 3. Methods for Alginate Regeneration

Regeneration and Re-use of Alginates: To recycle and re-use alginate, a method was utilized to remove the bound calcium from the alginate and produce the unbound alginate in either a solid or liquid (dissolved) form. The overall strategy undertaken was to use ion exchange and pH dependent solubility to achieve this.

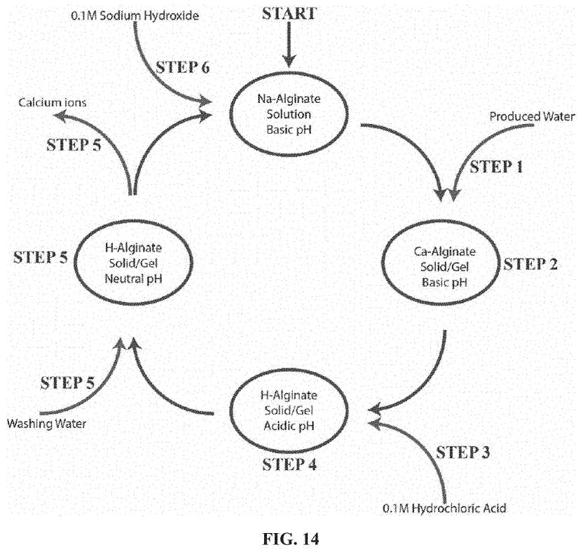

It is known that ion exchange with H⁺ ions will usually displace other bound ions due to the relative strength of the H⁺-Alginate complex over the Ca-Alginate complex. It is also known that alginic acid is not soluble below its pKa value with a corresponding pH of <3.5. Therefore, it was hypothesized that ion exchange of the bound Ca-alginate with acid would both displace the calcium and precipitate the alginate allowing it to be recovered and reused through filtration. The precipitated alginate can then be dissolved back into basic solution ready to re-use. The proposed recovery mechanism is shown below in FIG. 14.

The regeneration and re-use of the alginate is a simple eight step process that only has hydrochloric acid, sodium hydroxide, and water as input/output process streams.

Initially the Process Starts with the Sodium Alginate in Solution at a Basic pH

STEP 1: The sodium alginate solution is added to the process water stream. Any calcium in the process water (or other divalent ion to a much lesser extent) binds with the alginate to form a gel. This may be either a semi solid gelatinous mass of a much more dispersed “stringy” gel in the water.

STEP 2: The final solution includes produced water at a basic pH containing gelatinous materials of calcium bound alginate and still unbound (unused) alginate ions.

STEP 3: Addition of hydrochloric acid that lowers the pH of the solution to less than pH of 2. This keeps the calcium alginate in the solid/gel form and forces any unbound alginate to also precipitate therefore removing all alginate from solution.

STEP 4: Mixing of the acidic alginate gel solution ensures that the acid penetrates the gel. The hydrogen ions from the acid ion-exchange with the calcium from the alginate gel resulting in the formation of hydrogen alginate and free calcium ions in solution. The hydrogen alginate (alginic acid) is also insoluble at low pH and remains in a gelatinous state.

STEP 5: The alginic acid solution is filtered and washed with water. The gelatinous alginic acid is collected in the filter and the solution, containing the calcium ions (and any other ions previously bound to the alginate) is washed away. After washing with water, the filter contains gelatinous alginic acid (H-Alginate).

STEP 6: The collected alginic acid gel is placed into a container and then dissolved through the addition of sodium hydroxide. The alginic acid is soluble as long as the pH >4. The resulting solution is sodium alginate at basic pH, the original starting solution. Through this process the alginate can be fully regenerated and re-used numerous times for the removal of calcium from produced water.

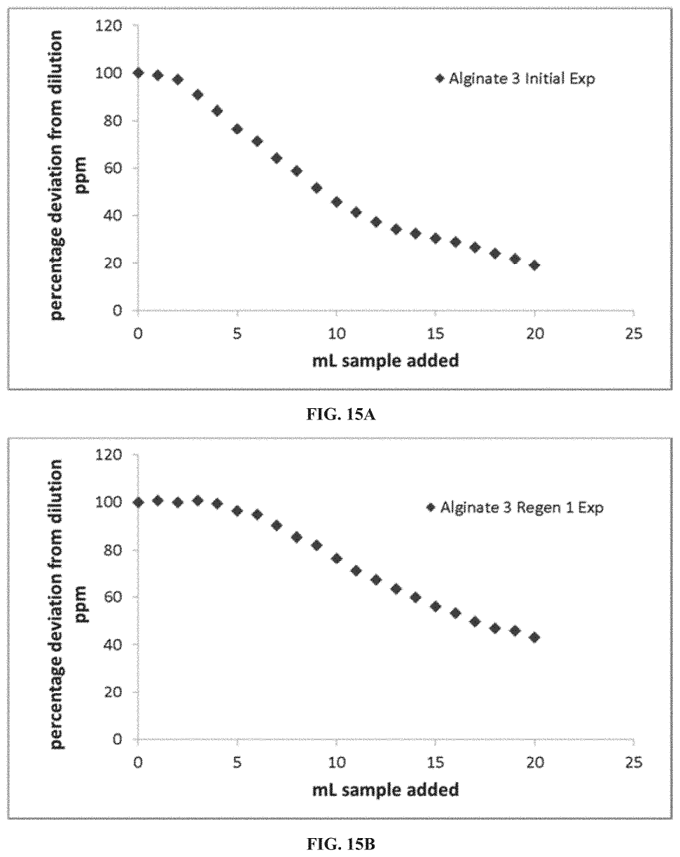

A 1% alginate solution was prepared and added in 1 mL aliquots to a 300 ppm solution of calcium ions as shown in FIG. 15A. The alginate performed as previously demonstrated by reducing the calcium in the “produced water”. After the trial was concluded, hydrochloric acid was added to the solution to precipitate all the alginate and ion-exchange the calcium into solution. The solid was then filtered and washed with deionized water to remove any residual calcium solution. The gelatinous alginic acid was then placed in a beaker and dissolved through the addition of sodium hydroxide solution.

The residual concentration of calcium in the regenerated sodium alginate was measured to be less than 3 ppm. This regenerated basic sodium alginate solution was then used to remove calcium from a 300 ppm solution as preformed previously as shown in FIG. 15B.

FIG. 15B appears to show the effectiveness of the alginate has decreased with the 20 mL addition of alginate decreasing the calcium concentration to approximately 40% of the original value when it usually decreases to 20% of the original value. This is not due to a decrease in alginate effectiveness but rather the solution was not as concentrated than the one used in the first experiment (<1%) due to the uncontrolled addition of base to redissolve the alginate. The use and regeneration was performed a further three times (five in total) with the alginate working well each time. Further regeneration still resulted in a calcium carryover of less than 3 ppm.

Conclusions: Alginates have met the challenges and requirements in their use as selective calcium binders and likely applicability as pH stabilized pipeline calcium scale control agents. More specifically alginates are capable of selectively binding to calcium ions under various pH and temperatures. Alginates with high “G/M” ratios are significantly better at calcium complexation. Alginate binding is not significantly affected by the presence of other divalent ions. Alginate calcium complex forms viscous gels which increase in viscosity with increasing calcium concentration. Calcium alginate gels form an equilibrium/buffer system with their surrounding solutions limiting how much calcium can be removed from solution. Removing formed gel from solution allows very low calcium concentration to be obtained in solution. The addition of alginate and base to a calcium bicarbonate solution removes calcium from solution and prevents the formation of calcium carbonate. Methods for alginate regeneration have been developed. Alginate powder and solutions thermally degrade under high prolonged temperatures. Thermally degraded alginates still bind calcium and have improved flow characteristics, both as solutions and the precipitate formed. Thermally degraded alginate solutions exhibit water like viscosities with no shear thinning.

The compositions and methods of the appended claims are not limited in scope by the specific compositions and methods described herein, which are intended as illustrations of a few aspects of the claims. Any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

What is claimed is:

1. A method of inhibiting formation of scale on equipment in contact with a produced fluid containing a scale-forming divalent cation, the method comprising:
thermally modifying an alginate precursor under conditions effective to afford an activated alginate that dissolves in less than 60 seconds into water and glycol phases at a concentration of 1% by weight at 25° C.;
adding the activated alginate to the produced fluid in an amount effective to react with the divalent cation in the produced fluid to form an activated alginate complex; and
separating the activated alginate complex from the produced fluid.

2. The method of claim 1, wherein thermally modifying the alginate precursor is performed in an open container or under inert atmosphere.

3. The method of claim 1, wherein the alginate precursor is thermally modified at a temperature of 80° C. or greater, such as 120° C. or greater, or 140° C. or greater.

4. The method of claim 3, wherein the temperature is from 140° C. to 180° C. for a period of at least 24 hours, such as a temperature of about 160° C. for a period of at least 24 hours.

5. A method of inhibiting formation of scale on equipment in contact with a produced fluid containing a scale-forming divalent cation, the method comprising:
heating an alginate precursor at a temperature of at least 140° C. for a period of at least 24 hours under conditions effective to form an activated alginate;
adding the activated alginate to the produced fluid in an amount effective to react with the divalent cation in the produced fluid to form an activated alginate complex; and
separating the activated alginate complex from the produced fluid.

6. The method of claim 5, wherein heating the alginate precursor is performed in an open container or under an inert atmosphere.

7. The method of claim 5, wherein the alginate precursor is heated at a temperature of 150° C. or greater.

8. The method of claim 5, wherein the alginate precursor is heated at a temperature of from 140° C. to 180° C. for a period of at least 24 hours.

9. A method of inhibiting formation of scale on equipment in contact with a produced fluid containing a scale-forming divalent cation, the method comprising:
adding an activated alginate to the produced fluid in an amount effective to react with the divalent cation in the produced fluid to form an activated alginate complex; and
separating the activated alginate complex from the produced fluid,
wherein the activated alginate exhibits a viscosity in water at 5% w/w of 10 cP or less at 4° C.

10. The method of claim 9, wherein the activated alginate is prepared by a process comprising thermally modifying, chemically modifying, or enzymatically modifying an alginate precursor.

11. The method of claim 10, wherein the activated alginate is prepared by a process comprising thermally modifying the alginate precursor, and wherein thermally modifying the alginate precursor is performed in an open container or under an inert atmosphere.

12. The method of claim 11, wherein the alginate precursor is thermally modified at a temperature of 80° C. or greater, such as 120° C. or greater, or 140° C. or greater.

13. The method of claim 12, wherein the temperature is from 140° C. to 180° C. for a period of at least 24 hours, such as a temperature of about 160° C. for a period of at least 24 hours.

14. The method of claim 1, wherein the activated alginate has an average particle size diameter of 1.4 μm or less, 1.0 μm or less, or 500 nm or less.

15. The method of claim 5, wherein the activated alginate exhibits increased rate of dissolution in water and glycol compared to the alginate precursor.

16. The method of claim 15, wherein the activated alginate dissolves in less than 60 seconds into water and glycol phases at a concentration of 1% by weight at 25° C.

17. The method of claim 1, wherein the activated alginate exhibits increased kinetics of complexation with the divalent cation compared to the alginate precursor.

18. The method of claim 1, wherein activated alginate has a molecular weight of 500,000 Da or less.

19. The method of claim 1, wherein the activated alginate is in the form of an activated alginate solution comprising 0.1% to 10% by weight activated alginate in the solution.

20. The method of claim 19, wherein the viscosity of the activated alginate solution is from about 2.3 cP to less than 10 cP at 4° C.

21. The method of claim 1, wherein the divalent cation and the activated alginate are in a ratio of 300 ppm divalent cation to 1% w/w activated alginate.

22. The method of claim 1, wherein the divalent cation is a calcium cation.

23. The method of claim 1, wherein the activated alginate complex comprises particles having a particle diameter of 1.0 μm or less.

24. The method of claim 1, wherein separating the activated alginate complex from the produced fluid is by gravity, a centrifuge, or any combination thereof.

25. The method of claim 1, further comprising recycling the activated alginate from the activated alginate complex.

26. The method of claim 25, wherein recycling the alginate complex comprises dissolving the activated alginate complex by adding an acid, a salt, or a washing fluid to the activated alginate complex.

27. The method of claim 1, wherein the equipment in contact with the produced fluid is a pipeline carrying the produced fluid.

28. The method of claim 1, wherein the produced fluid has a pH of greater than 7, preferably wherein the produced fluid has a pH from 7 to 12.
